(19) United States
(12) Patent Application Publication
(10) Pub. No.: US 2009/0319804 A1
(43) Pub. Date: Dec. 24, 2009

(54) Scalable and Extensible Architecture for Asymmetrical Cryptographic Acceleration

(75) Inventors: Zheng QI, San Jose, CA (US); Tao Long, Mountain View, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 12/121,693

(22) Filed: May 15, 2008

Related U.S. Application Data
(60) Provisional application No. 60/929,598, filed on Jul. 5, 2007.

(51) Int. Cl. G06F 17/00

(52) U.S. Cl. 713/190

(57) ABSTRACT

Systems and methods for providing asymmetrical cryptographic acceleration are provided. The scalable asymmetric cryptographic accelerator engine uses a layered approach based on the collaboration of firmware and hardware to perform a specific cryptographic operation. Upon receipt of a request for a cryptographic function, the system accesses a sequence of operations required to perform the requested function. A micro code sequence is prepared for each hardware operation and sent to the hardware module. The micro code sequence includes a set of load instructions, a set of data processing instructions, and a set of unload instructions. An instruction may include a register operand having a register type and a register index. Upon receipt of a load instruction, the hardware module updates size information in a content addressable memory for a register included in the instruction. The hardware module continuously monitors the content addressable memory to avoid buffer overflow or underflow conditions.

### CROSS REFERENCE TO RELATED APPLICATIONS

This application claims benefit of U.S. Provisional Application No. 60/929,598 entitled “Scalable and Extensive Architecture For Public Key Cryptographic Accelerator,” file Jul. 5, 2007, which is incorporated by reference herein in its entirety.

### FIELD OF THE INVENTION

The present invention relates generally to information security and specifically to asymmetrical cryptographic systems.

### BACKGROUND OF THE INVENTION

Many applications and devices rely on embedded cryptosystems to provide security for an application and its associated data. Previous asymmetrical cryptographic accelerators are designed using a pure hardware approach. In these accelerators, cryptographic functions as well as the size and format of the inputs to the accelerator are hard coded. The advantage of this approach is that these engines are extremely high performance. However, this pure hardware approach has limited flexibility to support new features or modifications to existing features. For example, as security requirements become more and more stringent, public and private key sizes are growing to increase the security of the algorithm used. In typical hardware accelerators, if the key size grows beyond the hard coded value supported by the hardware, the hardware can no longer handle the operation. Additionally, if a new operation is desired such as elliptic curve Diffie-Hellman, if the operation is not already hard coded into the accelerator, then the new operation cannot be implemented.

These hardware approaches also have a very simple command interface. In these accelerators, each public key operation is defined by a single command with a designated hardware function. The hardware engines also are designed to process one command at a time. The command output must be read back before a new command can be issued by the host processor.

Additionally, the pure hardware approach is difficult to scale down for embedded applications that require optimized area and power. Because software is completely excluded from the design, the hardware must have complicated sequencing state machines in order to carry out cryptographic operations. Therefore, the design cycle is extremely long.

What is therefore needed is a scalable and extensible system for accelerating cryptographic operations.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts a block diagram of an exemplary scalable cryptography accelerator engine (PKA), according to embodiments of the present invention.

FIG. 2 depicts a logical organization of firmware, according to embodiments of the present invention.

FIG. 3 depicts a block diagram of an exemplary public key accelerator (PKA) hardware module, according to embodiments of the invention.

FIG. 4 depicts an exemplary microcode sequence used during the computation of Z=(A+B) mod N followed by Z=A*C mod N, according to embodiments of the present invention.

FIG. 5 depicts an exemplary opcode parser, according to embodiments of the present invention.

FIG. 6 depicts a flowchart of a method for performing cryptographic functions, according to embodiments of the present invention.

FIGS. 7A-7D depict exemplary functions that may be called by an external application via the firmware API, according to embodiments of the present invention.

FIGS. 8A-B depict a flowchart of a method for performing cryptographic operations in a hardware module, according to embodiments of the present invention.

FIG. 9 depicts an exemplary opcode hierarchy used by micro sequencer, according to embodiments of the present invention.

FIG. 10 depicts an exemplary Diffie-Hellman key exchange.

FIG. 11 depicts an exemplary firmware code for generating the micro code sequence to generate a Diffie Hellman public value (e.g., X=g^{x} mod p), according to an embodiment of the present invention.

FIGS. 12A, B depict an exemplary micro code sequence generated by firmware for performing RSA decryption using the Chinese Remainder Theorem, according to an embodiment of the present invention.

FIGS. 13A1-3 depict exemplary micro code sequence generated by firmware for performing DSA signature generation, according to an embodiment of the present invention.

FIGS. 13B1-3 depict exemplary micro code sequence generated by firmware for performing DSA signature verification, according to an embodiment of the present invention.

FIG. 14A, B depict an exemplary micro code sequence generated by firmware for performing prime field elliptic cryptography point addition, according to an embodiment of the present invention.

FIG. 15A,B depict an exemplary micro code sequence generated by firmware for performing prime field elliptic cryptography point doubling, according to an embodiment of the present invention.

FIG. 16 depicts an exemplary Elliptic Curve Diffie-Hellman key exchange.

FIG. 17 depicts a flowchart of an exemplary method for performing prime number preselection using the sifting approach, according to embodiments of the present invention.

FIG. 18 depicts a block diagram of an exemplary general purpose computer system.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

### 1.0 Structural Embodiments

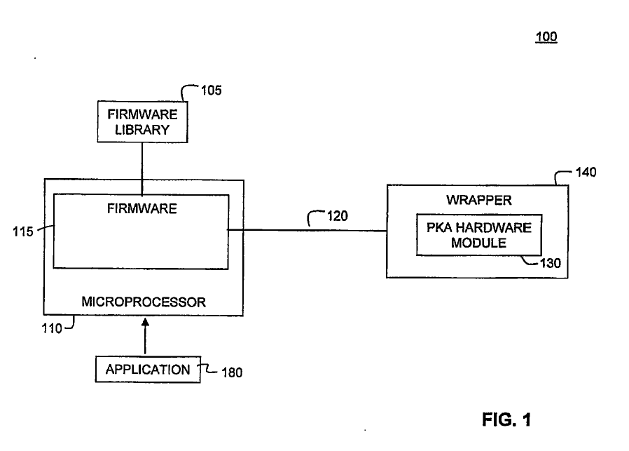

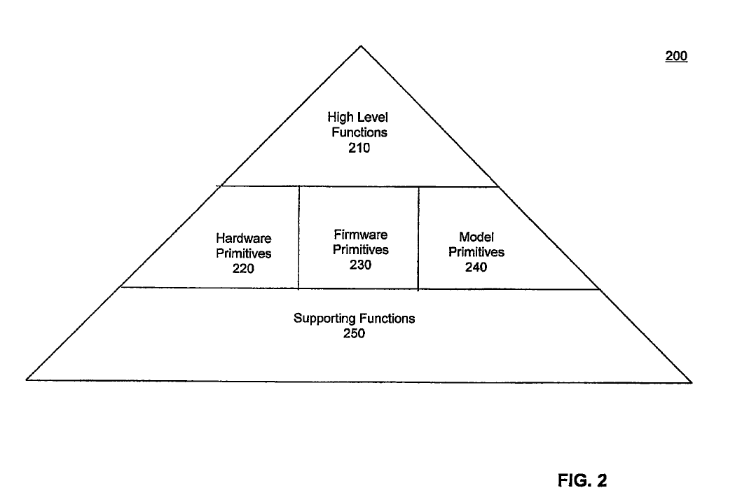

FIG. 1 depicts a block diagram of an exemplary scalable asymmetrical cryptographic accelerator engine (PKA) 100, according to embodiments of the present invention. PKA engine 100 uses a layered approach based on the collaboration of firmware and hardware to perform a specific cryptographic operation. In this approach, a cryptographic operation may in turn be composed of a set of high level functions. Top-down consideration is given to the algorithmic nature of the function so that the most optimized result can be achieved for the overall system. This firmware/hardware (FW/HW) collaboration approach provides increased flexibility for different types of applications requiring cryptographic processing.

A cryptographic function is composed of multiple arithmetic operations. In the collaborative firmware/hardware approach, a set of arithmetic operations are implemented in hardware and a set of arithmetic operations are implemented in firmware. These hardware and software operations represent the building blocks on which higher level functions can be constructed. The firmware is configured to sequence the available software and/or hardware operations to perform the higher level function. If a function requires an operation not supported by the hardware or firmware, a new firmware operation can be developed and added to the system. In addition, new functions utilizing existing hardware and/or software operations can be implemented as needed. Thus, the flexible partition of hardware and software allows new functionality to be accomplished via firmware upgrades rather than changes to the hardware.

The embodiments of the invention are described with reference to cryptographic operations for ease of discussion. As would be appreciated by persons of skill in the art, other mathematical functions, particularly those that require modulo operations for large size integers, can be performed using the architecture and methods described herein.

In PKA engine 100, cryptographic operations are broken down into multiple layers. The higher layer non-computation intensive operations are implemented in firmware. The lower layer computation intensive operations are implemented in hardware. Additionally, a portion of the firmware is configured to prepare a micro code instruction sequence to be carried out by the hardware. In an embodiment, this portion of the firmware is dedicated to the function of generating the required micro code instruction sequences.

PKA engine 100 includes a microprocessor 110 coupled to PKA hardware module 130 via a connection 120. In an embodiment, connection 120 is a bus. Firmware 115 runs on target microprocessor 110.

In general, firmware 115 decomposes a cryptographic function into a sequence of operations. Firmware 115 is configured to schedule the performance of the sequence of operations by PKA hardware module, by software, or by a combination of both hardware and software. For example, firmware 115 may decompose RSA decryption into a series of exponentiation operations followed by modular multiplications and modular additions.

In an embodiment, data transfers between microprocessor (or host processor) 110 and PKA module 130 are handled through a memory-mapped input/output (IO) and/or possibly a direct memory access (DMA) controller. In an alternate embodiment, the PKA hardware module interfaces with the coprocessor bus of a specific microprocessor. In this embodiment, data transfer between the firmware and hardware is more efficient than memory-mapped IO embodiment. However, this embodiment makes the firmware and hardware platform dependent and limits the ability to connect the hardware to a DMA or another hardware module.

PKA engine 100 also includes a platform independent firmware library 105. Platform independent firmware library 105 may be targeted to a generic microprocessor or microcontroller for handling top level sequencing.

Many off-the-shelf cryptographic libraries such as OpenSSL, GNU GMP or RSA BSAFE use dynamic memory allocation for long integer operations. Dynamic memory allocation requires support from an operating system. More over, it is less efficient in terms of performance and code size. The approaches to dynamic memory allocation are advantageous for pure software implementations because these approaches allow a large amount of memory to be allocated using heap memory space. Additionally, these software packages use the allocated memory to build look-up tables in order to optimize speed. However, this approach is not suitable for embedded systems such as SmartCards, etc., because these systems have severe memory limitations.

In an embodiment, firmware library 105 uses a pre-defined scratch memory and a simple stack-based memory allocation scheme. This scheme improves the efficiency of the code. However, in this embodiment, library 105 is not reentrant. Memory allocated for long integer structures must be de-allocated in the same routine in the reverse order.

PKA hardware module 130 provides a hardware core that supports a set of basic computationally intensive operations. PKA hardware module 130 is described in further detail in FIG. 3, below. Wrapper 140 provides an interface for the PKA hardware module 130 to bridge into different architectures. Wrapper may support multiple IO interfaces (e.g., a register access interface and/or a streaming interface). In an embodiment, microprocessor 110 and PKA hardware module 130 are on the same chip. In alternative embodiments, microprocessor 110 is on a separate chip from PKA module 130.

In an alternate embodiment, PKA system 100 may include multiple hardware modules 130. In this embodiment, two or more of the hardware modules 130 may support a different set of hardware operations.

Application 180 is an application that requires a cryptographic operation. The application 180 accesses the functions necessary to perform the cryptographic operation via firmware 115.

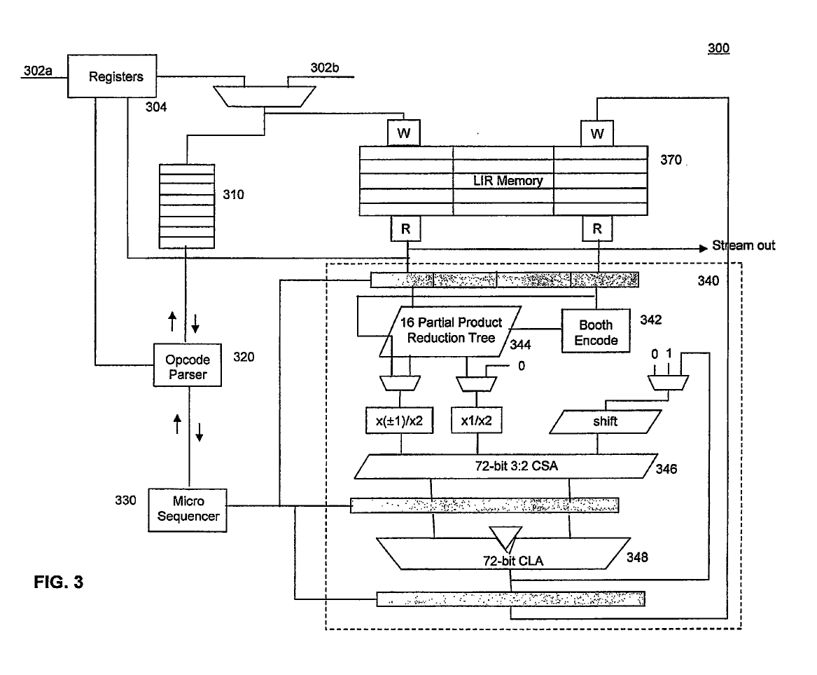

FIG. 2 depicts a logical organization 200 of firmware 115, according to embodiments of the present invention. Firmware 115 decomposes a higher level cryptographic function into individual steps and determines which agent (e.g., hardware or software) carries out each step.

High level function 210 is top level application programming interface (API). The top level functions 210 are API routines that can be compiled to implement a specific cryptographic operation. These functions are not mapped to hardware. The API presents a set of functional units (or routines) supported by PKA system 100. As discussed above, underneath the common API, firmware 115 may support different or multiple PKA hardware modules. By presenting a common API, the specific architecture of PKA system is abstracted from the application (and in turn, from the developer of the application software).

The high level functions 210 are further decomposed by other components of the firmware to carry out the necessary operations. A high level function may call hardware and/or software primitives to perform the function. For example, Diffie-Hellman, DSA, and RSA may be completely mapped to hardware operations whereas ECDH and ECDSA are partially mapped to hardware operations. Therefore, Diffie-Hellman, DSA, and RSA can be represented by single micro-code sequences that are prepared and sent to hardware in a single pass. Whereas, ECDH and ECDSA are represented by multiple micro code sequences that are sent to hardware in a software loop.

In an embodiment, the firmware is synchronous. When a long sequence is dispatched to hardware, the microprocessor is configured to perform other operations instead of waiting until the hardware completes the requested operation. For example, the firmware may poll a hardware status bit. If the status bit indicates that the hardware has not completed processing the operation, the firmware allows certain function calls (e.g., an external yield function). The yield function is a routine provided to perform a task including, but not limited to functions such as housekeeping, serving a user's input, etc. The yield function is also a mechanism to provide a multitasking system to put the current PKA software process to sleep and then invoke it later when a task completion interrupt is received from the PKA hardware module.

Hardware primitives 220 are routines that perform the hardware calls to implement the primitive functions. The hardware primitive 220 is configured to decompose a higher level function to specific operation or operations and to drive PKA hardware module 130 to carry out the decomposed operation or operations. The hardware primitives are firmware code that generate the microcode sequences sent to hardware module 130 for computation.

Firmware primitives 230 are performance-optimized firmware routines intended for software implementation or for performance comparison. These routines may be coded with platform dependent assembly language to handle CARRY propagation or SIMD which are hard to deal with using high level programming languages like C.

Model primitives 240 are optional. When present, model primitives 240 provide a mechanism to model math operations using off-the-shelf proven libraries such as GMP and OpenSSL/Crypto libraries. When present, model primitives 330 allow for rapid prototyping and modeling.

Supporting functions 250 perform low level functions such as memory management functions or error reporting functions. The code at this level does not have knowledge of math functions that firmware 115 is trying to implement.

FIG. 3 depicts a block diagram of an exemplary public key accelerator (PKA) hardware module 300, according to embodiments of the invention. Existing public key cryptographic hardware engines have a very simple command interface. In these engines, each public key operation is defined by a single command with a designated opcode. These hardware engines process one command at a time. The command output must be read back before a new command can be issued by the host processor. Additionally, each command is independent from other commands.

In PKA hardware module 300, each command represents a microcode sequence that allows multiple primitive operations to be mixed. The length of the command is limited by the internal memory size of the PKA module and the size of the operands embedded in the command sequence.

PKA instructions can be divided into two general categories: data transfer instructions and data processing instructions. A data transfer instruction transfers data from a host processor to the large integer registers (LIRs) or reads the value of a LIR back to the host processor. Example data transfer opcodes include “move to” opcodes (e.g., MTLIR, MTLIRI) that move data to a LIR, “move from” opcodes (e.g, MFLIR, MFLIRI) that move data from a LIR, a “clear” opcode (e.g., CLIR) that clears a LIR, and a SLIR that sets a LIR value to a small immediate value. The data transfer opcodes may be represented by a single 32-bit instruction followed by an optional immediate operand.

The use of microcode instructions to load and unload LIRs allows data structures such as the Montgomery context to be preloaded for the entire public key operation. It also allows the output of one command instruction to be reused by a subsequent command instruction.

A data processing instruction causes data processing to be performed using internal registers. In an embodiment, data processing instructions are two 32-bit instructions that can carry up to five operands per instruction. Typically, the data processing opcodes do not have associated immediate operands in the microcode sequence. Example data processing opcodes include modular addition, modular subtraction, and modular multiplication.

An opcode is specified in the most significant octet of an instruction. The most significant bit (MSB) of the opcode indicates whether additional opcodes remain in the command sequence. For example, the MSB is set to indicate that the opcode is the last opcode of the command sequence. Module 300 uses this bit to perform housekeeping tasks such as de-allocating LIRs or clearing memory. The remaining seven bits of the most significant octet is encoded with the opcode. An exemplary opcode formate is shown below:

| Bit Range | Description |
|---|---|
| [7] | 1- last opcode, 0 - more opcodes to follow |
| [6:0] | Opcode enumeration |

The instruction also includes a destination operand. In an embodiment, the first operand following the opcode is the destination operand. The destination operand may be a 12-bit operand. For data transfer opcodes, the last operand is an immediate operand that contains the size of the data operand embedded or the size of the operation. In an embodiment, PKA module 200 may track the size of data stored in LIR 370 for performance optimization. The size of data in the last operand is specified in a number of octets. For data processing opcodes, the next four operands are source operands. In an embodiment, the first three operands are 12-bit operands and the last operand is an 8-bit operand.

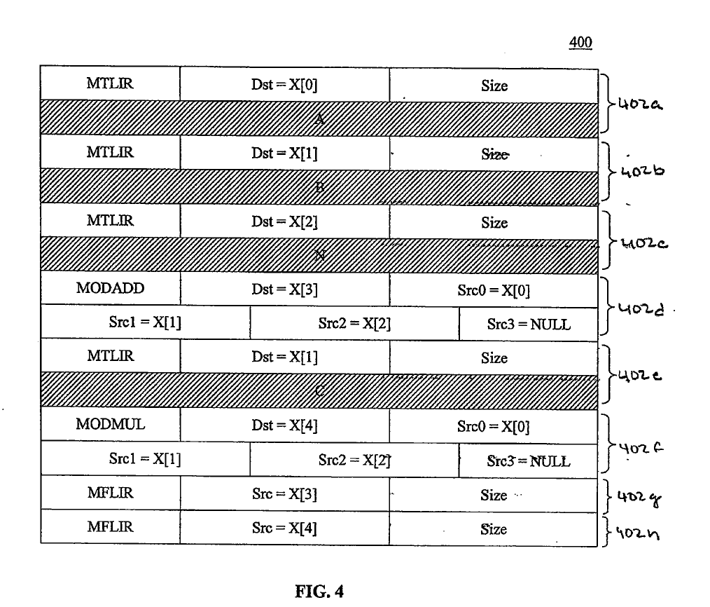

FIG. 4 depicts an exemplary microcode sequence 400 used during the computation of Z=(A+B) mod N followed by Z=A*C mod N, according to embodiments of the present invention. Microcode sequence 400 includes the following eight instructions 402a-h:

| | |
|---|---|
| MTLIR (X[0], SIZE_A, A) | 402a |
| MTLIR (X[1], SIZE_B, B) | 402b |
| MTLIR (X[2], SIZE_N, N) | 402c |
| MODADD (X[3], X[0], X[1], X[2]) | 402d |
| MTLIR (X[4], SIZE_C, C) | 402e |
| MODMUL (X[4], X[0], X[4], X[2]) | 402f |
| MFLIR (X[3], SIZE_N) | 402g |
| MFLIR (X[4], SIZE_N) | 402h |

Instructions 402a-c are data transfer instructions that load the input parameters into the internal memory of the PKA hardware. The grey-shaded area in the first three instructions represents an immediate operand (e.g., the data to be transferred). Instruction 402d performs the computation, Z=(A+B) mod N. Instruction 402e loads an additional input parameter required for the subsequent computation performed in instruction 402f of Z=A*C mod N. In this example, the input parameters A and N required for the second operation MODMUL do not need to be reloaded into memory of the PKA hardware. The final two instructions 402g, 402h are also data transfer instructions that read back the output of the two operations after the operations are completed.

Microcode sequences for additional cryptographic operations are described in Section 2 below.

PKA module 300 includes one or more Input/Output (IO) interfaces 302. A host processor (e.g., firmware 115) (not shown) communicates a command sequence to PKA module 300 via an IO interface 302. For example, microprocessor 110 may communicate a prepared microcode sequence to PKA module 300. If the PKA module 300 includes multiple IO interfaces, the host processor communicates the command sequence via one of the IO interfaces. Multiple IO interfaces are typically not used concurrently.

PKA module 300 may include a register access interface 302a. Register access interface 302a is coupled to a register block 304. Register block 304 includes a set of registers from which a host processor can read or write. Register access interface 302a may write a sequence of operations to perform into the opcode FIFO queue 310. The register access interface 302a may also initialize data in large integer register (LIR) memory 370.

A host processor may request a command to be sent through register access interface 302a. In an embodiment, the host processor may write a field (e.g., PKA_LOCK) to an access control register (not shown) to request a resource lock and to monitor the “locked” status. The PKA hardware grants the host access if the streaming interface 302b is idle. The host then owns the PKA hardware unless the host explicitly releases the lock by clearing the “locked” status. If the host is the only entity accessing the PKA module 300, the lock can be set once when the system in initiated (e.g., at boot-up). A host may send a command sequence to PKA module 300 by writing the sequence to a DATA_IN register in register block 304 one command word at a time. When the host is transferring data to the PKA memory, the target register must be free.

PKA module 300 may also include a streaming interface 302b. Streaming interface 302b is used to stream a command into PKA module 300 and stream out the result after the command has completed. Streaming interface 302b is typically used with a DMA controller (not shown).

Although FIG. 3 depicts PKA module 300 as having both a register access interface 302a and a streaming interface 302b, module 300 may optionally implement the streaming interface. In embodiments, the register access interface 302a is required for configuration, status, and interrupt. The register access interface 302a may not be used in these embodiments for data transfer.

Large Integer Register (LIR) memory 370 is coupled to register block 304, streaming interface 302b, and datapath 340. Although LIR 370 is referred to as a register, in an embodiment, LIR 370 is implemented with a memory. In an embodiment, the internal memory of PKA 300 is mapped to a special set of large integer registers (LIRs) that can be indexed in the microcode. This mapping allows the reuse of data that is already in the PKA memory and avoids unnecessary data loading and unloading. In an embodiment, memory 370 includes different types of LIRs with different predefined sizes. These LIRs are UNIONed on the same memory.

In an embodiment, hardware module 130 requires some scratch space to hold temporary results. The scratch memory in PKA module 130 is allocated from the top memory address of the LIR memory. In other words, the scratch space is allocated in the same fashion as a heap. The user space starts from address 0.

A microcode instruction such as described above may include a register operand (e.g., Dst=X[3], Src1=X[1], Src2=X[2] in instruction 402d). A host processor sources data to LIR 370 and pulls data from LIR memory (e.g., through register access interface 302a) using these register operands. A format for an exemplary 12-bit register operand is shown below.

| Bit Range | Description |
|---|---|
| [11:8] | LIR Type |
| [7:0] | LIR Index |

For example, a 12-bit register operand is divided into a 4-bit field LIR type and an 8-bit LIR index. A 8-bit register operand is divided into a 4-bit LIR type and a 4-bit LIR index. The maximum addressable index is limited by the internal memory allocated for addressable LIRs. The following table depicts exemplary LIR Types.

| LIR Type | Encoding | Size (bytes) |
|---|---|---|
| NULL | 0x0 | 0 |
| A | 0x1 | 8 |
| B | 0x2 | 16 |
| C | 0x3 | 32 |
| D | 0x4 | 64 |
| E | 0x5 | 96 |
| F | 0x6 | 128 |
| G | 0x7 | 192 |
| H | 0x8 | 256 |
| I | 0x9 | 384 |
| J | 0xA | 512 |

Opcode parser 320 is coupled to opcode FIFO queue 310, register block 304, and micro sequencer 330. Opcode parser 320 is configured to control the flow of the microcode sequence from opcode FIFO queue 310. The opcode parser is configured to read one opcode at a time from opcode FIFO queue 310. The opcode parser 320 also checks the incoming opcode stream for the opcodes requiring immediate action (e.g., the “move to” data transfer or “set” opcodes) and stores the immediate data in the command to LIR memory. These opcodes are not placed into the opcode queue 310. The opcode parser 320 is also configured to control the queuing of the remaining opcodes and to schedule opcode dispatch to micro sequencer 330. That is, the opcode parser 320 interprets the requested operation and passes the operation to the micro sequencer 330. Upon completion of the opcode, opcode parser 320 retires the opcode from queue 310. The opcode parser also controls the return of data to the host by detecting “move from” opcodes.

Opcode parser 320 is further configured to translate the register indices included in register operands to base addresses in the LIR memory. Opcode parser 320 also keeps track of the actual data size of a number of LIR registers (e.g., 16) using a content addressable memory.

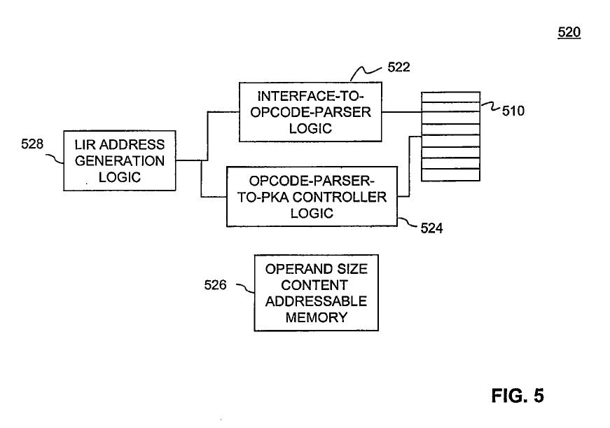

FIG. 5 depicts an exemplary opcode parser 520, according to embodiments of the present invention. Exemplary opcode parser 520 includes Interface-to-Opcode-Parser logic 522, Opcode-Parser-to-PKA-Controller Logic 524, Operand Size CAM 526, and LIR Address Generation Logic 528. Opcode Queue FIFO 510 may also be considered a component of opcode parser 520.

Interface-to-Opcode-Parser logic 522 is configured to direct certain opcodes to the opcode queue FIFO and to direct data from the “move to” opcodes to the LIR memory. The “move to” opcodes may contain a large number of data words. As a result, these two instructions are not queued in the opcode FIFO. Instead, the data words are written immediately to the LIR memory as they arrive. The PKA hardware core may be stalled while these “move to” opcodes are processed.

In an embodiment, Interface-to-Opcode-Parser logic 522 includes a finite state machine (FSM) and some supporting logic. The FSM waits for valid opcode data from the interface to the hardware module 300.

Opcode-Parser-to-PKA-Controller logic 524 is configured to monitor the opcode queue FIFO and perform certain processing based on the detected opcode. In an embodiment, the opcode-parser-to-PKA-controller logic block 524 includes a finite state machine (FSM) and supporting logic. Opcode-Parser-to-PKA Controller logic 524 reads and parses the first portion (e.g., first word) of the operand. For single word operands, the first portion includes the opcode, the destination register, and an immediate value. For double word operands, the first portion contains the opcode, destination register, and source register. The register indices contained in the first portion are translated to the corresponding base addresses in the LIR memory.

If the opcode is a “move from” opcode, the FSM reads the requested data from the LIR memory and delivers the data to the interface of the hardware module. In certain circumstances, each word will be cleared to zero once it is read out and the operand size information is also cleared in the operand size CAM 526. If the opcode is a “set” LIR (SLIR) opcode, the FSM writes the immediate value to the LIR memory and updates the operand size information in the operand size CAM to one word.

If the opcode has two words, the FSM next reads out Word 1 from the Output FIFO 510. Word 1 contains the source 1 register, the source 2 register, and the source 3 register. The register indices are translated to the corresponding base addresses in the LIR memory. The size information for each of the source registers is retrieved from the operand size CAM 526. The destination size is computed and written to the operand size CAM 526. The finite state machine is further configured to send the decoded opcode with all its parameters to the PKA micro sequencer. The FSM waits until the micro sequencer completes the opcode.

The micro sequencer can complete an opcode faster if the operand size information is provided. Operand Size CAM 526 is configured to store operand size information. As described above, PKA hardware memory includes a set of registers having different sizes. If the input is smaller than the size of the register then basing operations on the size of the register rather than the size of the data in memory decreases the efficiency of the hardware. For example, if the input is 65 bits, a 128-bit register must be used. However, treating the data as the full 128-bits increases the time required to process the data. Therefore, the CAM tracks the real length of the data stored in memory.

Operand Size CAM 526 stores multiple entries, each entry having a LIR register index (including, for example, type and index fields) and an encoded operand word size. In an embodiment, the value in the encoded operand word size field is the actual word size minus one. For example, if the size of an operand is five words, then the value stored in this field is four. When the write enable input is not set, CAM 526 takes a single clock cycle to resolve size information. If the LIR index is not found, then the output is zero. When the write enable input is set and an entry with the matching LIR index is found, then CAM 526 updates the size information with the new value. If the entry is new, then CAM 526 uses the empty slot with the lowest index to store the size value.

LIR address generation logic 528 is configured to translate LIR register index values to physical memory addresses. LIR address logic 528 is shared by interface-to-parser logic 522 and parser-to-PKA logic 524. For certain memory access opcodes (e.g., “move to” and “move from” opcodes), LIR address generation logic 528 is configured to generate offsets as well.

Returning to FIG. 3, opcode FIFO queue 310 holds the sequence of opcodes received via one of the IO interfaces 302. Opcode FIFO queue may store all the opcodes except for certain opcodes immediately executed such as “move to” and “set” opcodes. In an embodiment, opcode FIFO queue 310 is implemented with a dual-ported memory. If FIFO 310 is a 64×32 memory, FIFO 310 can store 32 double-word opcodes. The opcode FIFO depth can be adjusted for area and performance tradeoffs without impacting functionality.

Micro Sequencer 330 is coupled to opcode parser 320 and data path block 340. In an embodiment, micro sequencer 330 is a finite state machine (FSM) that controls the execution of a single opcode. Micro sequencer 330 accesses data size information from CAM 526 then schedules the operation in the most efficient way based on the size of the data and not the total size of the register. Micro sequencer 330 controls operand fetch, pipeline operation, and result write back. The micro sequencer 330 controls memory access of the data path 340 to LIR memory 370 and coordinates computational units within the data path 340. The micro sequencer 330 generates a control signal to the data path 340. In an embodiment, the micro sequencer generates pipeline control and multiplexer select signals for the data path. The pipeline control signals determine when output from the previous pipeline stage can advance to the next stage. In an embodiment, data path control logic generates the pipeline control and multiplexer select signals.

In an embodiment, the sequencer FSM includes an N-entry stack. For example, upon entering the initialization state of an opcode, the return state and operand size information at the current level are pushed to the N-entry stack. Once the opcode is completed, the FSM pops the stack to find out the return state and restores the previous state information. The stack enables complex opcodes to be built on simpler ones. For example, the MODEXP opcode calls CLIR, MODMUL, MODREM, MODSQR, MOVDAT, RDLIR, and W2LIR routines. In turn, MODSQR opcode calls the SQR and MODMUL routines. The MODMUL opcocde calls the LADD, LCMP, LSUB, MOVDAT, and MUL routines. The depth of the stack limits the call depth.

Micro sequencer 330 is further configured to manage operand base addresses, manage temporary registers, and generate final LIR addresses. In an embodiment, these functions are performed by an LIR memory interface that may be a five-entry stack. In addition to implementing the steps for each opcode, the sequencer is further configured to generate operand word offsets. These offsets are provided to the LIR memory interface block for final address generation.

Data path 340 includes one or more math computational units. In an embodiment, the main data path 340 is a customized 32×32 multiplier-accumulator data path. The data path may be a four-cycle pipeline including one stage to fetch operands from the LIR memory, two stages for ALU/MAC and one stage for write back.

For example, in a given cycle, the following operations can be performed:
Two 32-bit operands can be fetched to perform a 32×32 multiplication with accumulation in two cycles
Two 32-bit operands can be fetched to perform a 32-bit addition or subtraction
One 64-bit operand can be fetched to perform a shift operation
   In an embodiment, a 72-bit shifter is added to the accumulation datapath to facilitate the long integer multiplication. The final carry propagation stage uses a 72-bit adder to accommodate the carry overflow accumulated over many iterations of the long integer multiplication.

Data path 340 may include a Booth encode module 342, a 16 partial produce reduction tree 344, a carry-save adder (CSA) 346, and a carry look-ahead (CLA) adder 348. As would be appreciated by persons of skill in the art, data path 340 may include additional or alternative units, as required by a specific application.

### 2. Methods

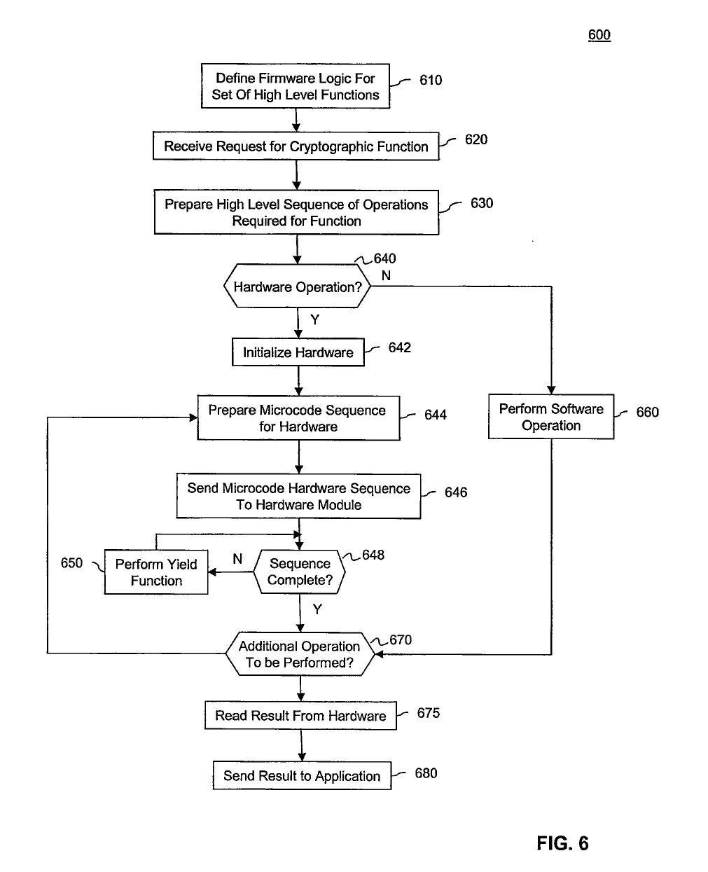

FIG. 6 depicts a flowchart 600 of a method for performing cryptographic functions, according to embodiments of the present invention. FIG. 6 is described with reference to FIG. 1. However, the method is not limited to that embodiment. Note that the steps of flowchart 600 do not necessarily have to occur in the order shown.

In step 610, firmware logic for a set of high level functions is defined and loaded into firmware 115. This step may occur at any time. For example, an initial set of functions may be defined prior to deployment of PKA system 100.

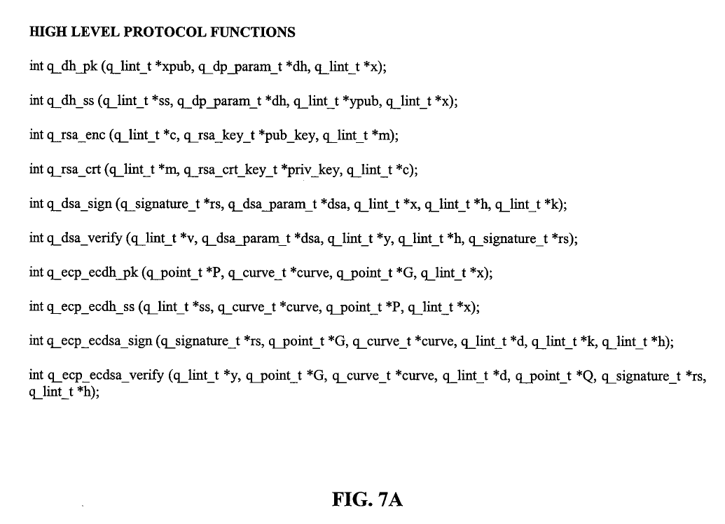

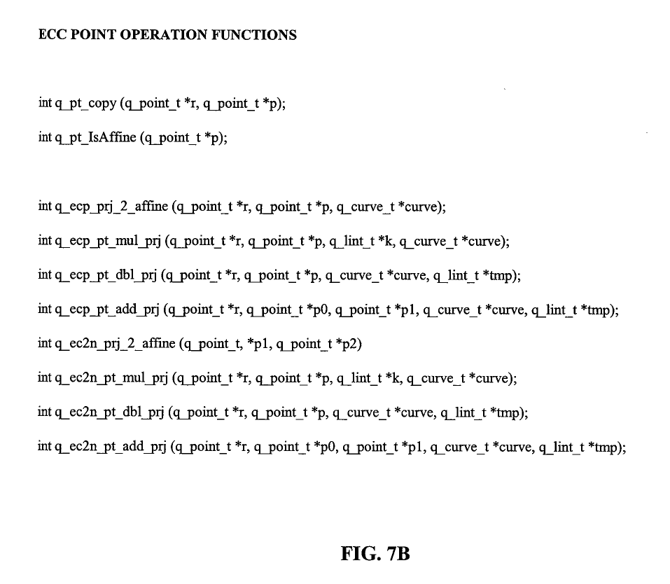

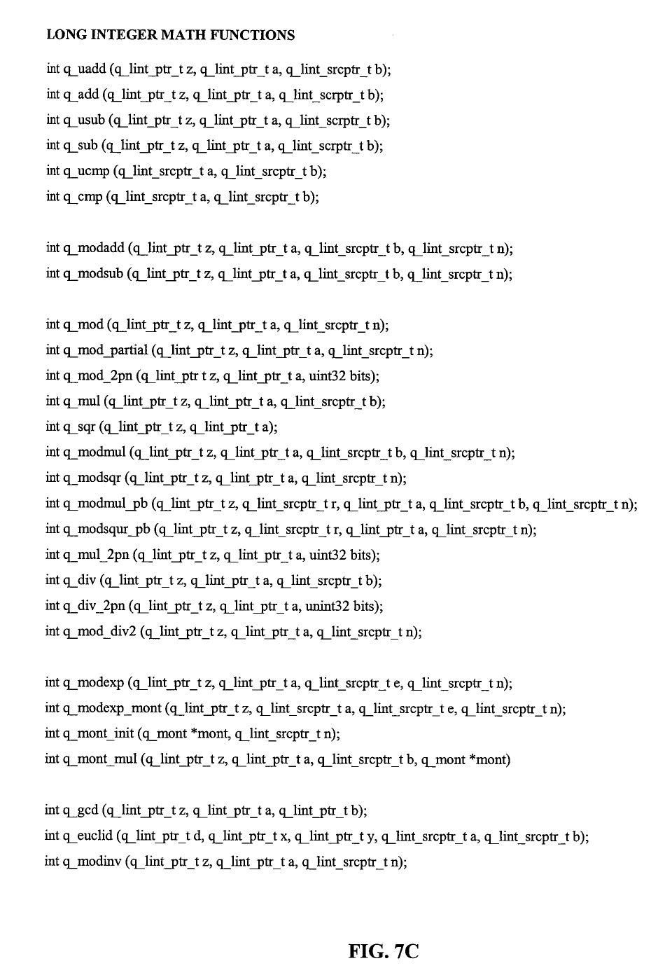

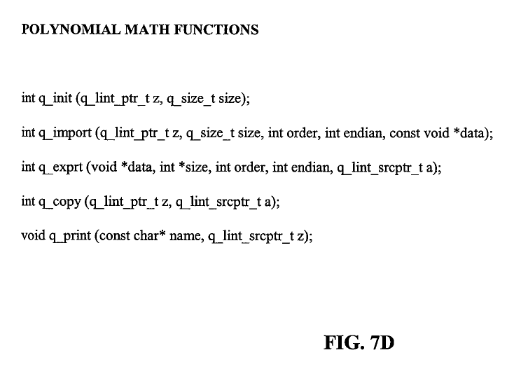

Additional functionality may later be added via a firmware upgrade. Each function may be called by an external application via the firmware API. Example functions are depicted in FIGS. 7A-D. The functions in FIGS. 7A-D are split into four groups: PKA high level protocol functions, elliptic curve cryptography point operations, PKA long integer math functions, and PKA polynomial math functions. The PKA high level protocol functions include, for example, Diffie-Hellman public key, Diffie-Hellman shared secret, RSA encryption and decryption, elliptical curve Diffie-Hellman public key and shared secret, DSA signature generation and signature verification, and elliptical curve DSA signature generation and verification.

In step 620, firmware 115 receives a request for a cryptographic function and the parameters required for the operation. For example, the firmware 115 may receive the request via the firmware API.

In step 630, the firmware 115 prepares and schedules a high level sequence of operations required for the function. The sequence of operations may be performed by the hardware module, by software, or by a combination of hardware and software. That is, the sequence of operations may involve calls to one or more hardware primitives and/or one or more software primitives. The sequence of operations to be performed is dependent upon the characteristics of the cryptographic function to be performed.

For example, Diffie-Hellman functions (public key, shared secret) and RSA encryption utilize a single modulo exponentiation operation with very large modulus sizes. There are very few parameters to pass in to the operation. However, they all tend to be very large. The sequencing for these functions is very regular and straight forward. The sequencing includes two aspects: sequencing on exponentiation and sequencing on long integer operation. The high level Diffie-Hellman functions and RSA encryption function are performed in firmware. Note that the firmware may call one or more hardware primitives to generate a hardware microcode sequence.

RSA decryption using Chinese Remainder Theorem (CRT), DSA signature generation, and DSA signature verification includes a set of modulo exponentiation operations that require an additional level of sequencing. RSA decryption and DSA functions are performed in firmware. Note that the firmware may call one or more hardware primitives to generate a hardware microcode sequence.

Generic modular math includes the set of primitives that can be used as building blocks for more complicated functions. These primitives have the most significant impact to the performance of a more complicated function such as Diffie-Hellman or RSA.

The basic primitive operations like MODADD, MODSUB, MODMUL are built into PKA hardware because these primitives may be used by many upper layer functions. Data transfer would be very inefficient if these functions are implemented partially in firmware. For modular exponentiation, due to the large number of iterations involved in MODEXP function for large exponents (like in Diffie-Hellman and RSA) and relatively few inputs, the modular exponentiation function is implemented in hardware.

Using projective coordinates, elliptic curve cryptography (ECC) point doubling and point addition are represented as complicated sequences of modulo additions, subtractions, and multiplications. No modulo exponentiation is involved except during the coordinate conversion step. These complicated sequences fragment the operation flow, tend to make pipelining harder and require more temporary storage. The modulus size tends to be very small (on the order of ⅛ of the RSA modulus). This helps mitigate the memory requirement.

ECC point doubling and point addition functions invoke many MODMUL, MODADD, and MODSUB operations in a complicated sequence. If the two functions are completely disassembled into primitives, the sequence would be too long to be sent to the hardware module in one pass. The IO overhead would negatively impact the performance of the PKA system. Therefore, ECC point doubling and point addition sequences are performed at least partially in hardware.

ECC point multiplication includes an iteration of ECC point doubling and point addition with some initialization steps and post conversion steps. Since the multiplicand is relatively small, if the non-adjacent form (NAF) encoding method is used, the number of iterations is on average ⅓ of the size of the multiplicand. ECC point multiplication is performed in firmware.

ECC Diffie-Hellman (ECDH) and ECC DSA (ECDSA) include protocol level sequencing of ECC point multiplication mixed with modulo math (for ECDSA functions).

In step 640, a determination is made whether the operation being processed in the firmware sequence is a hardware operation (e.g., a call to one or more hardware primitives). For example, the Diffie-Hellman public key (described in detail below in Section 3.1) calculation requires a modulo exponentiation operation. Modulo exponentiation as described above may be provided as a hardware primitive. If the operation is a hardware operation, flowchart 600 proceeds to step 642. If the operation is not a hardware operation, operation proceeds to step 660.

In step 642, firmware 115 initializes the PKA hardware module 130.

In step 644, the microcode sequence required to perform the operation is prepared. A typical microcode sequence involves three primary aspects—opcode(s) to load the required parameters into LIR memory, opcode(s) to perform the operation, and opcode(s) to unload the result(s) from LIR memory. Example hardware microcode sequences for public key cryptographic functions/operations are described in detail below. In an embodiment, the microcode sequence is prepared by the hardware primitives.

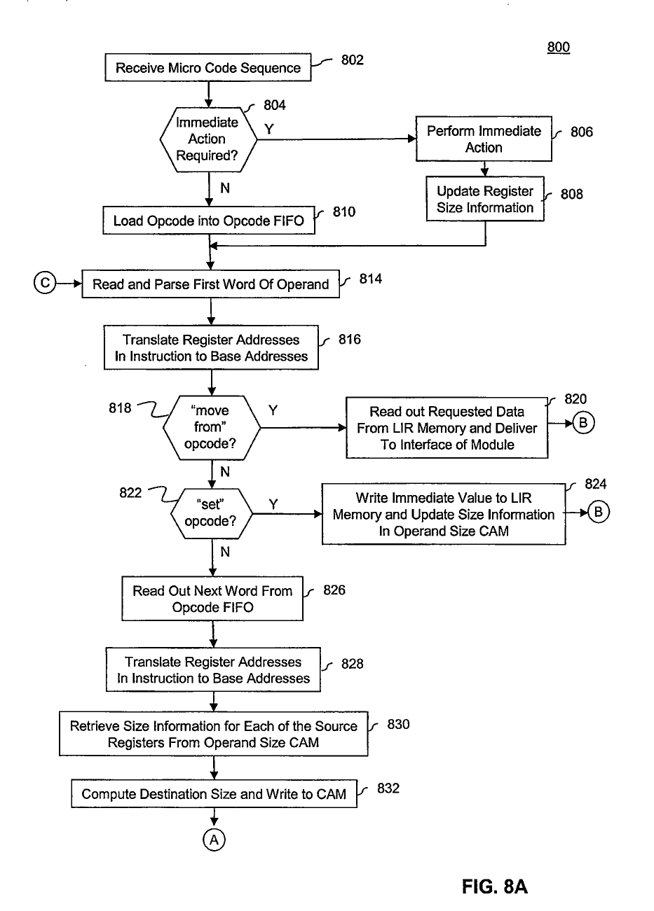

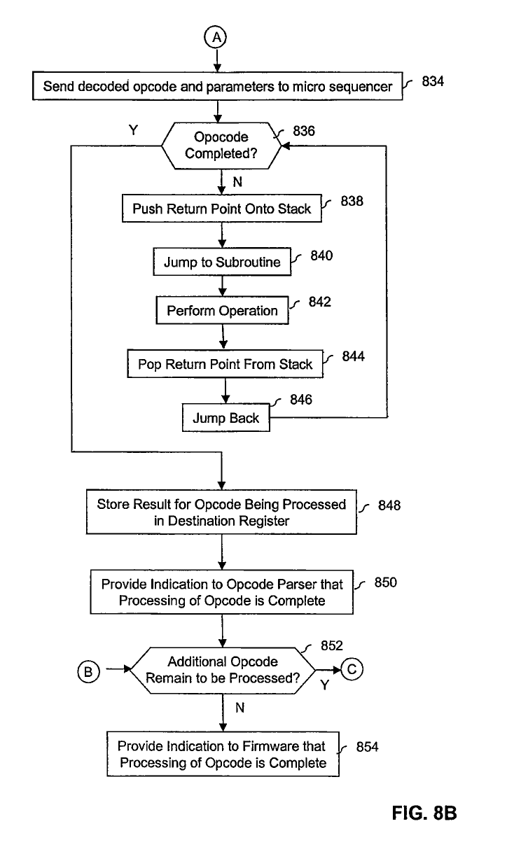

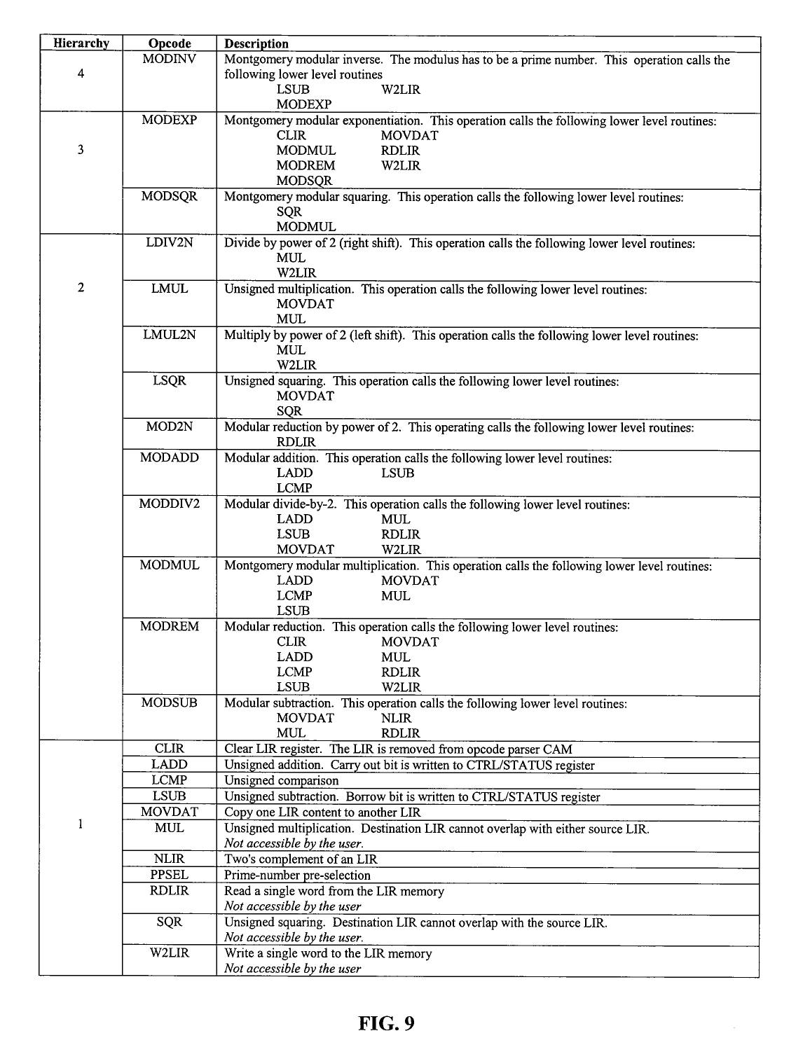

In step 646, the prepared hardware microcode sequence is sent to the PKA hardware module 130. In an embodiment, firmware 115 waits until PKA hardware module 130 is not busy to send the hardware microcode sequence. Details on an exemplary method for processing a received microcode sequence in hardware are discussed relative to FIG. 8 below.

In step 648, firmware 115 determines whether PKA hardware 130 has completed processing of the microcode sequence. In an embodiment, firmware 115 repeatedly polls a status bit to make this determination. If hardware module 130 processing is not complete, flowchart 600 proceeds to step 650. If hardware processing is complete, flowchart 600 proceeds to step 670.

In step 650, firmware 115 performs other functions while hardware module 130 is processing the microcode sequence. For example, firmware 115 may perform any requested yield function including, but not limited to, housekeeping functions, serving a user's input, etc. Processing then returns to step 648.

In step 660, the operation is performed in software.

In step 670, a determination is made whether additional operations remain to be performed. For example, ECC multiplication requires an iteration of ECC point doubling and point addition. In the first iteration of step 640, a first point addition or point doubling operation may be performed. In this step, the firmware sequence for ECC multiplication may indicate that a subsequent point addition or point doubling may need to be performed. If an additional operation is required, flowchart 600 returns to step 644. If no additional operations are required, flowchart 600 proceeds to step 675.

In step 675, the result or results from the microcode sequence are read back from hardware module 130.

In step 680, the result or results are returned to the application or entity that requested the cryptographic function.

FIGS. 8A-B depict a flowchart 800 of a method for performing cryptographic operations in a hardware module 130, according to embodiments of the present invention. FIGS. 8A-B are described with reference to FIG. 3. However, the method is not limited to that embodiment. Note that the steps of flowchart 800 do not necessarily have to occur in the order shown.

In step 802, the microcode sequence is received by the hardware module. As described above, a microcode command sequence includes a set of instructions. Each instruction includes an opcode that indicates the operation to be performed by the hardware.

The instructions are processed as they are received. In step 804, a determination is made whether a received opcode requires immediate action. For example, the “move to” opcodes are processed immediately by the opcode parser 320. If the opcode being processed requires immediate action, flowchart 800 proceeds to step 806. If the opcode does not require immediate action, flowchart 800 proceeds to step 810.

In step 806, the requested action is performed. For example, if a “move to” opcode is received, the immediate data in the instruction is stored in LIR memory.

In step 808, register size information for the registers used in step 806 is updated in the operand size CAM 526. The flowchart then proceeds to step 812.

In step 810, the received opcode is loaded into the opcode FIFO 310.

A finite state machine in opcode parser 320 monitors the opcode FIFO 310. When an opcode is detected, the following steps are performed. The opcode parser can be considered as having two separate sets of logic. The first half of the logic (as represented by steps 804-810) is responsible for feeding opcodes from the host CPU to the opcode FIFO 310. The second half of the logic (as represented by steps 812-834) is responsible for dispatching an opcode in the FIFO. These two sets of logic may operated in parallel. For example, provided the opcode FIFO is not empty, the second FIFO will be actively dispatching an opcode. Similarly, as long as the FIFO is not full, the first half of the logic will fill the FIFO with new opcodes.

In step 814, opcode parser 320 reads and parses the first word (word 0) of the operand. For single word operands, word 0 contains the opcode in bits [31:24], a destination register in bits [23:12], and an immediate value [11:0]. For double word operands, word 0 contains the opcode [31:24], destination register [23:12], and a source register [11:0].

In step 816, the register addresses in the instruction are translated to the corresponding base addresses in the LIR memory.

In step 818, a determination is made whether the opcode being processed by opcode parser 320 is a “move from” opcode. If the opcode is a “move from” opcode, flowchart 800 proceeds to step 820. If the opcode is not a “move from” opcode, flowchart 800 proceeds to step 822.

In step 820, opcode parser 320 reads out the requested data from the LIR memory and delivers the data to the interface of the hardware module. If a memory on read bit is set in the hardware control register, then each word is cleared to zero once it is read out. In addition, the operand size information is cleared from operand size CAM 526. Flowchart 800 then proceeds to step 836.

In step 822, a determination is made whether the opcode being processed by opcode parser 320 is a “set” opcode. If the opcode is a “set” opcode, flowchart 800 proceeds to step 824. If the opcode is not a “set” opcode, flowchart 800 proceeds to step 826.

In step 824, opcode parser 320 writes the immediate value to the LIR memory and updates operand size information in operand size CAM 526. Flowchart 800 then proceeds to step 836.

In step 826, opcode parser 320 reads out the next word (word 1) from opcode FIFO 310 if the opcode has two words. Word 1 includes a source 1 register operand in bits [31:20], a source 2 register operation in bits [19:8] and a source 3 register operand in bits [7:0].

In step 828, the register indices from the register operands are translated to the corresponding base addresses in the LIR memory.

In step 830, size information for each of the source registers is retrieved from operand size CAM 526.

In step 832, the destination size is computed and written to operand size CAM 26.

In step 834, the decoded opcode with all its corresponding parameters are sent to micro sequencer 330. The opcode parser then waits until the micro sequencer completes the opcode.

In step 836, a determination is made whether processing of the opcode is completed. If processing of the opcode is completed, the flowchart proceeds to step 848. If processing of the opcode is not completed, the flowchart proceeds to step 838.

As discussed above, an opcode may be built upon simpler operations. For example, the MODEXP opcode calls MODSQR and MODMUL operations and in turn, the MODSQR or MODMUL operations call LMUL, LADD and LCMP operations. FIG. 9 depicts an exemplary opcode hierarchy used by micro sequencer 330, according to embodiments of the present invention.

In step 838, the return point is pushed onto the stack.

In step 840, the micro sequencer jumps to the subroutine to be performed.

In step 842, the subroutine operation is performed by the data path.

In step 844, the return point is popped from the stack

In step 846, the micro sequencer jumps back to the return point. The flowchart then returns to step 836.

In step 848, the result for the opcode being processed is stored in the destination register indicated in the instruction.

In step 850, micro sequencer 330 provides an indication to opcode parser 320 that processing of the opcode is completed. Opcode parser 320 retires the processed opcode from the opcode FIFO 310.

In step 852, a determination is made whether additional opcodes remain to be processed. As described above, opcode parser monitors the FIFO queue for additional opcodes. If additional opcodes are detected, flowchart 800 returns to step 814. If not additional opcodes are detected, flowchart 800 proceeds to step 850.

In step 854, PKA hardware module indicates to firmware that processing of the opcode has completed.

### 2.1 Diffie-Hellman Key Exchange

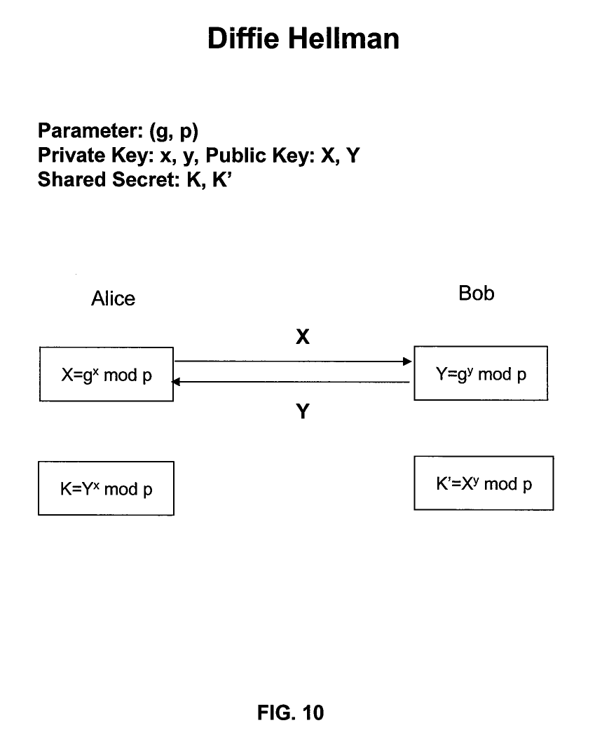

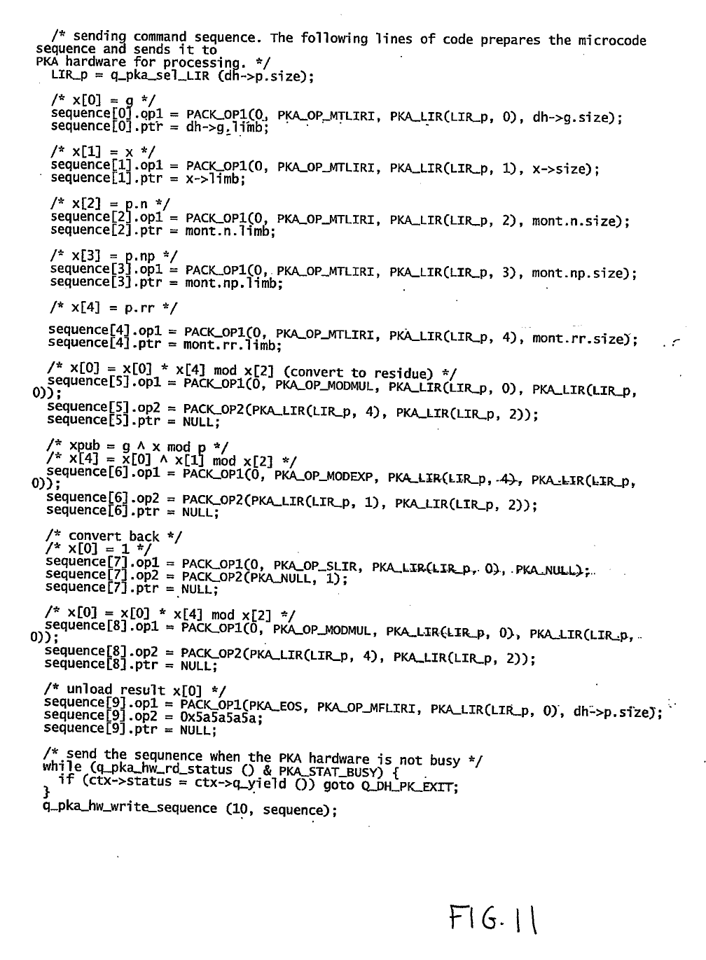

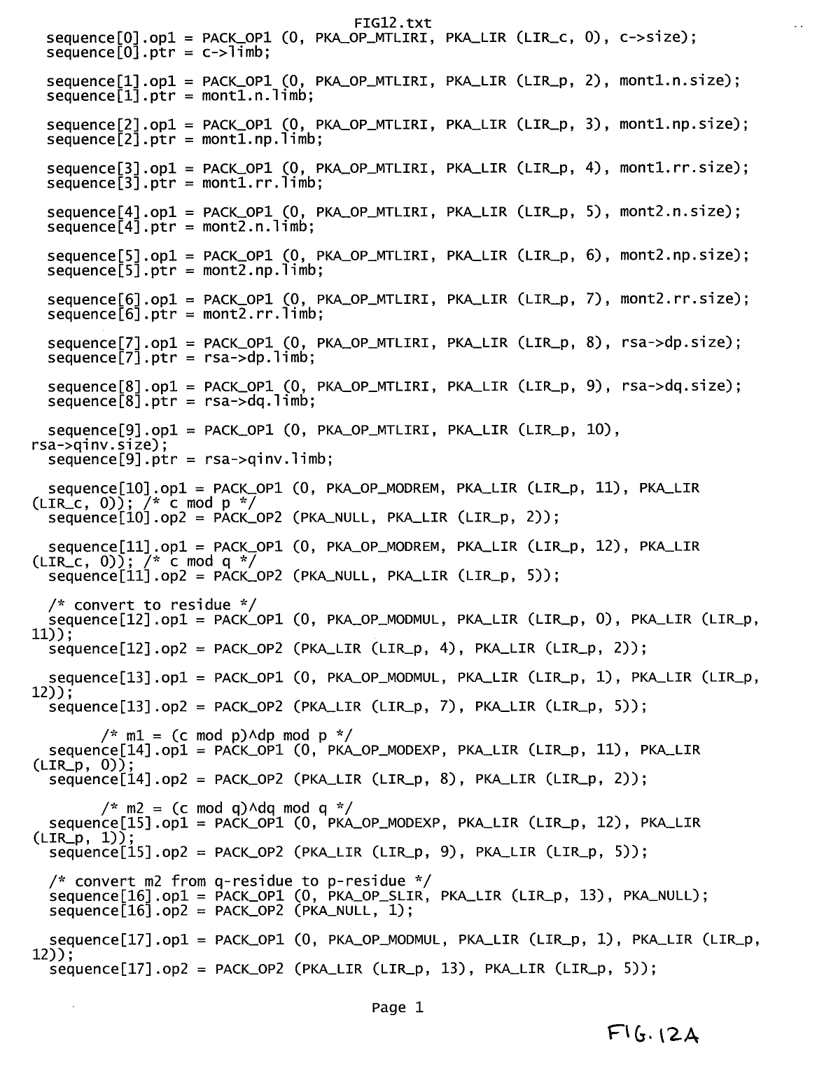

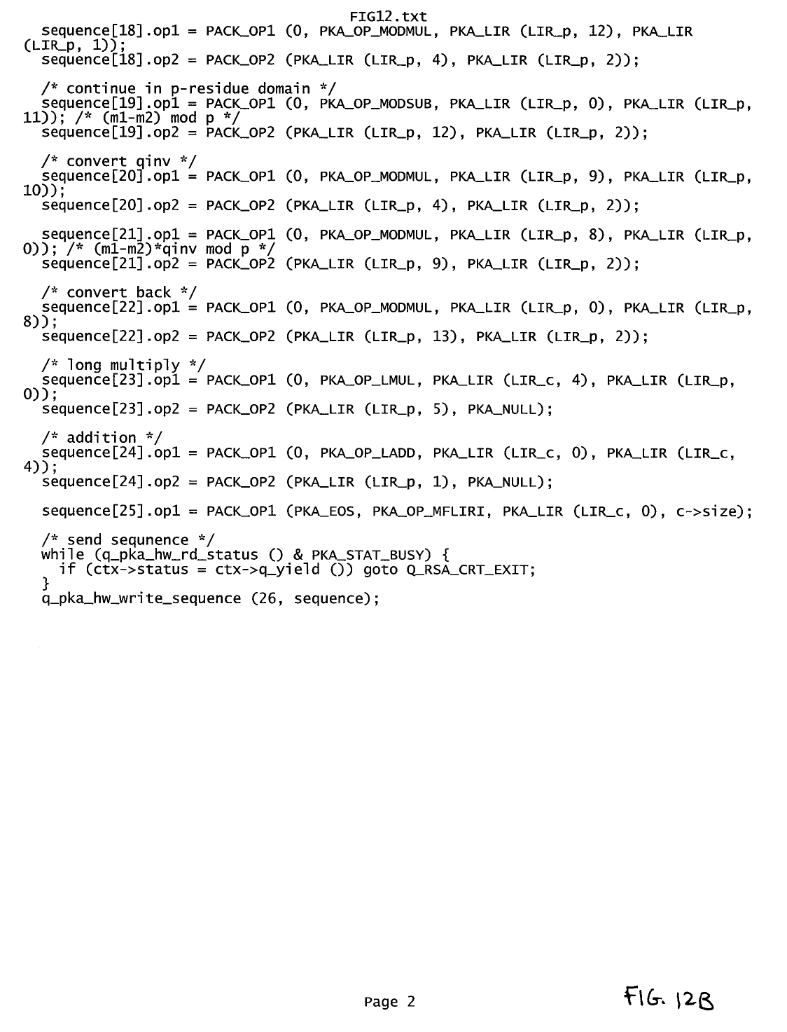

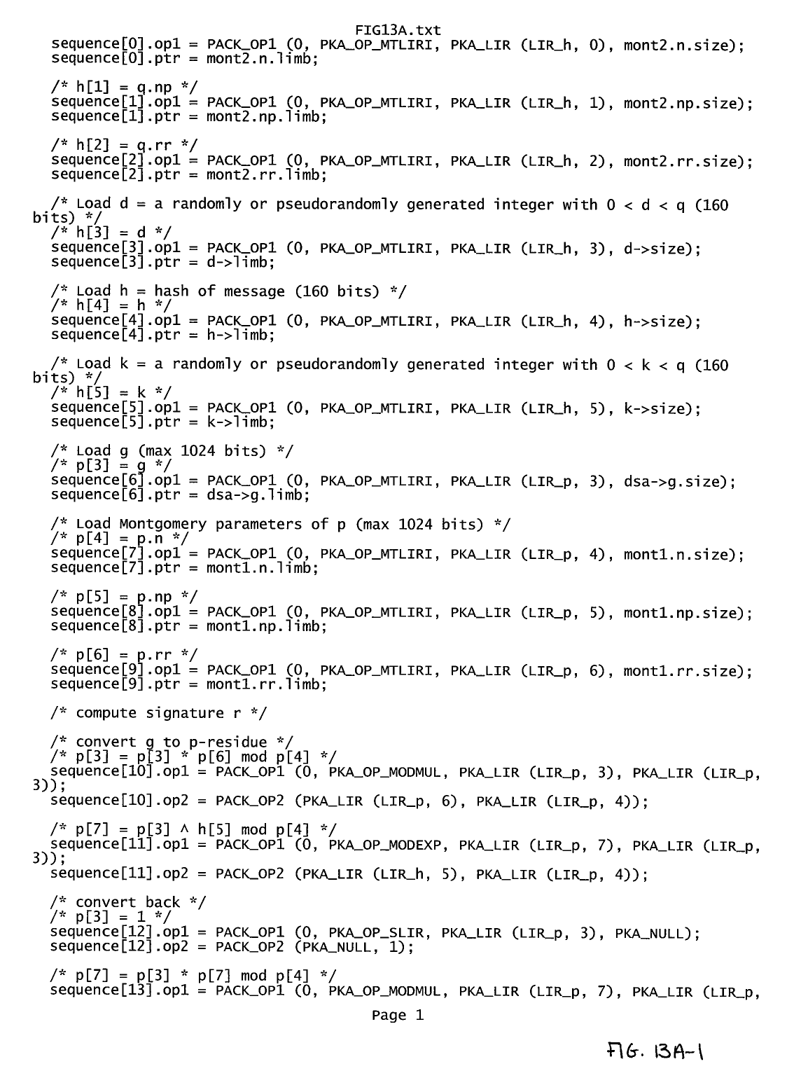

The Diffie-Hellman key exchange algorithm defines a mechanism to establish a shared-secret between two parties communicating with each other without a prior arrangement. This mechanism is based on discrete logarithm cryptography. FIG. 10 depicts an exemplary Diffie-Hellman key exchange.

In the Diffie-Hellman key exchange, two parties (e.g., Alice and Bob) agree upon a set of parameters. The set of parameters includes an odd prime modulus, p, and a base integer, g such that g<p. Each party then chooses a randomly generated number (denoted in FIG. A as x for Alice and y for Bob) which is less than p. Alice then computes X=g^{x} mod p and Bob computes Y=g^{y} mod p. The values x and y are referred to as the secret values of the parties. The values X and Y are referred to as the public values of the parties.

The two parties exchange their public values, X and Y. The secret values, x and y, are kept locally unexposed. The parties then compute the shared secret value. For example, Alice computes S2=Y^{x} mod p and Bob computes S1=X^{y} mod p. Mathematically S1=S2=g^{xy} mod p. A third party will not be able to obtain the shared secret without knowing either x or y. When p is significantly large, it is mathematically impractical to compute x and y using brute force from Y or X.

In an embodiment, PKA firmware 115 is designed to support generation of the Diffie Hellman public values and generation of Diffie Hellman shared secrets. An application can initiate performance of either Diffie Hellman function via a function call supported by the firmware API. As described above, firmware 115 decomposes each of these high level functions into sequences of operations required to perform the function.

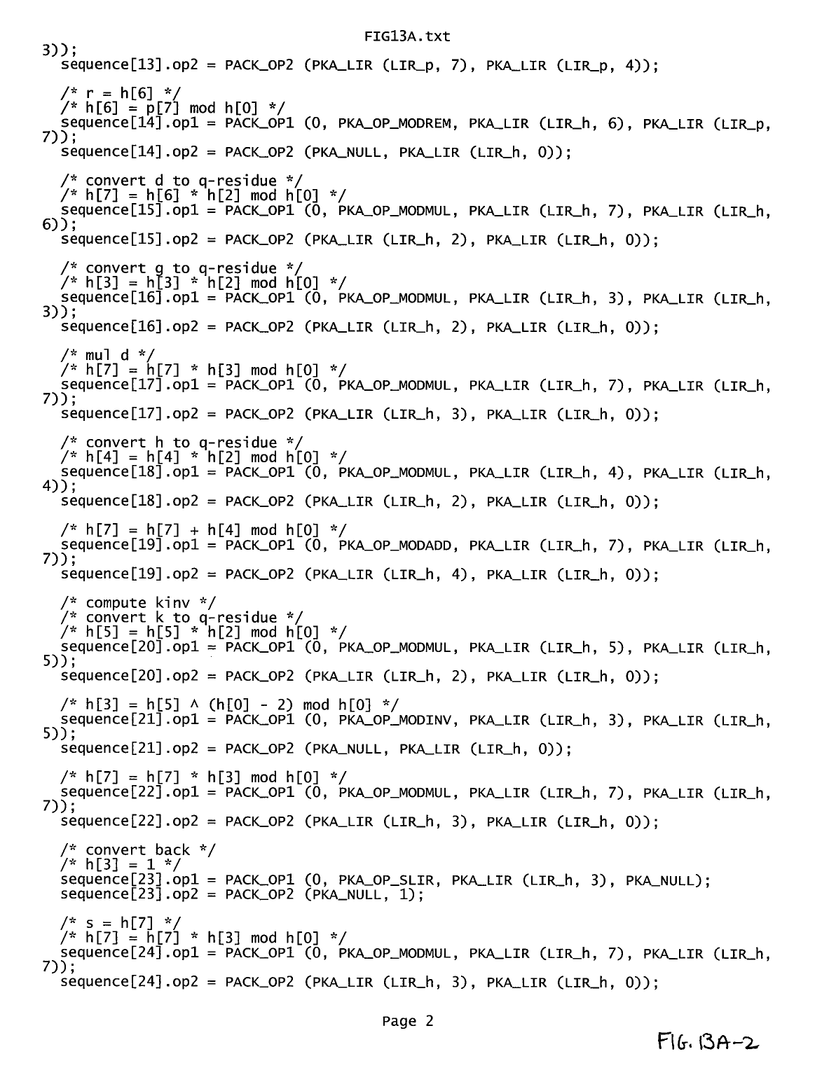

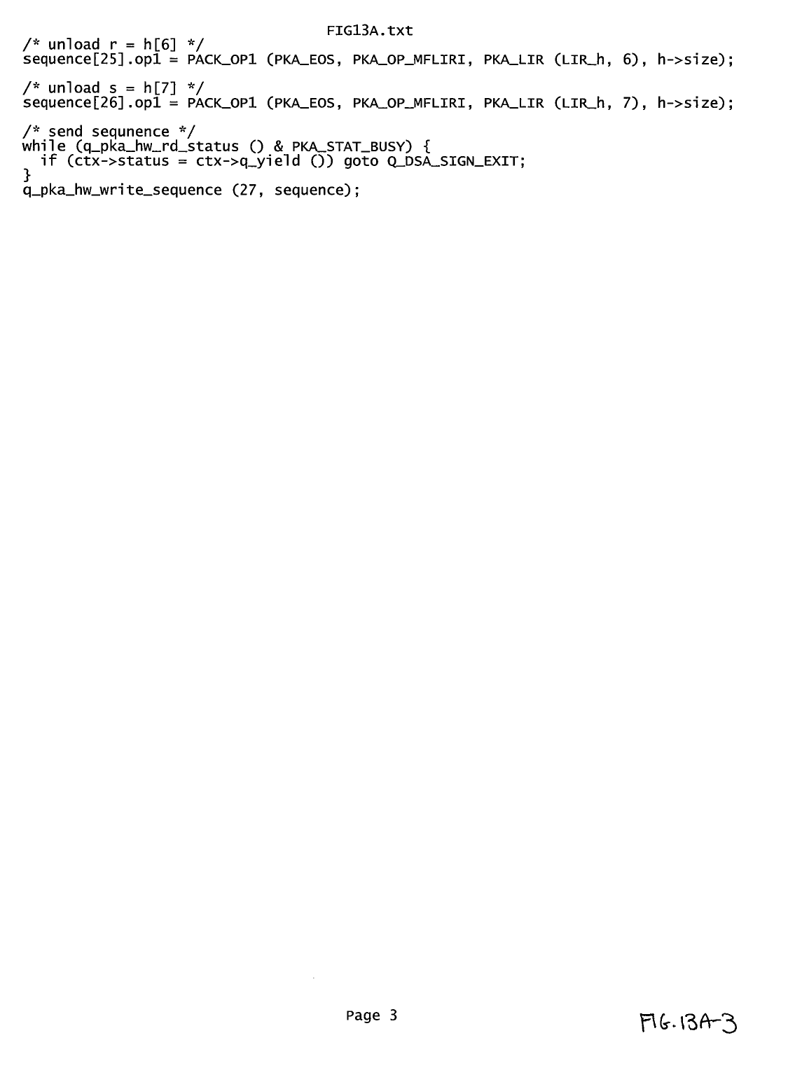

FIG. 11 depicts an exemplary firmware code 1100 for generating the micro code sequence to generate a Diffie Hellman public value (e.g., X=g^{x} mod p), according to an embodiment of the present invention. For example, this code may be part of the firmware sequence generated into step 630 of FIG. 6. As illustrated in FIG. 11, the first 5 code blocks, 1110a-e, load parameters required to perform the Diffie Hellman public value into LIR memory. The following 4 code blocks, 1120a-d, generate the opcode instructions required to perform the public value calculation. The last code block, 1130, unloads the result from LIR memory.

### 2.2 RSA Encryption/Decryption

The RSA algorithm is a two-key asymmetrical algorithm used in public key encryption and digital signing. The cryptographic strength of the RSA algorithm is based on the mathematical difficulty of factoring large numbers. In the RSA algorithm, a modulus, n, is generated based on two large prime numbers p and q where n=p*q. The modulus, n, is published together with an exponent e, which is a relative prime to (p−1)*(q−1). The pair (n,e) is the public key of the party. This public key is published by the party for use by others wishing to send encrypted messages to the party.

The party then computes d=e⁻¹ mod(p−1)(q−1). The pair (n,d) is the private key of the party. After computation of d, p and q are destroyed.

To encrypt a message, m, to send to the party, the message originator uses the party's public key to compute c=m^{e} mod n. The value, c, is the cipher text of the original message.

A received message can be decrypted by computing m=c^{d} mod n, using the party's private key. When n is significantly large, it is mathematically impractical to decrypt the message without the knowledge of d.

One technique for performing RSA decryption is based on the Chinese Remainder Theorem (CRT). In practice, the size of the RSA modulus, n, is at least 512-bits and often, 1024-bit and 2048-bit modulo are used. The private exponent, d, is on the same order of the modulus. Because of this large exponent, the decryption operation is a significantly slow operation. The speed of RSA decryption can be increased by using the Chinese Remainder Theorem (CRT).

Chinese Remainder Theorem (CRT) states that the computation of M=C^{d}(mod pq) can be broken into the following two parts:

M₁=C^{d}(mod p)

M₂=C^{d}(mod q)

The final value of M can be computed as:

M=((M₁−M₂)*(q⁻¹ mod p))mod p)*q+M₂

The real saving comes when it is proven that:

M₁=C^{d1}(mod p)

M₂=C^{d2}(mod q)

Where

d₁=d mod(p−1)

d₂=d mod(p−1)

Assuming p and q are typically half of the size of n=pq, the saving is significant by replacing one full size exponentiation with two half size exponentiation.

In an embodiment, the PKA firmware is designed to support the RSA cryptographic functions including public key generation, encryption, and decryption. An application can initiate performance of the function via a function call supported by the firmware API. As described above, firmware 115 decomposes each of these high level functions into sequences of operations required to perform the function.

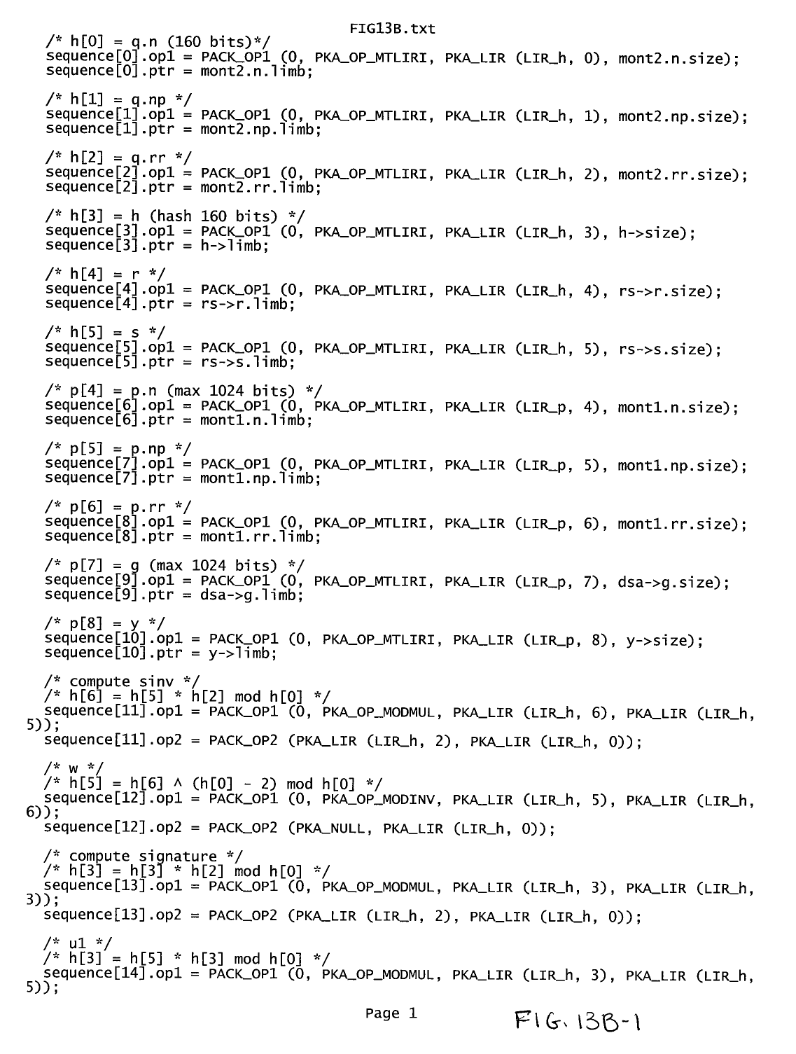

FIGS. 12A,B depict an exemplary micro code sequence 1200 generated by firmware 115 for performing RSA decryption using the Chinese Remainder Theorem, according to an embodiment of the present invention. The instructions load the parameters required to perform the RSA-CRT decryption function, effectuate the RSA-CRT decryption function, and unload the result of the decryption.

### 2.3 Digital Signature Standard (DSS)

The digital signature standard includes two core functions—signature generation and verification. In the signature procedure, a party computes two values r and s:

r=(g^{k} mod p)mod q, where
p is an L-bit long prime modulus, 2^{L-1}<p<2^{L} where L is an integer multiple of 64 greater than or equal to 512 and less than or equal to 1024
q is a 160-bit prime factor of (p−1), in other words 2¹⁵⁹<q<2¹⁶⁰
g=h^{(p-1)/q} mod p, where h is any integer with 1<h<(p−1) such that h^{(p-1)/q} mod p is greater than 1 (g has order q mod p)
k=a randomly or pseudo randomly generated integer with 0<k<q

s=(k⁻¹ (hash(M)+xr))mod q, where
x is a randomly or pseudo randomly generated integer with 0<x<q
   The pair (r,s) forms the digital signature of the message m, which can be sent together with the message m and the public key for the receiving party to verify the authenticity of the message.

In the verification procedure, the receiving party computes:

w=s⁻¹ mod q

u1=(hash(M)*w)mod q

u2=(r*w)mod q

v=((g^{u1}*y^{u2})mod p)mod q

The signature is successfully verified if v=r.

In an embodiment, the PKA firmware is designed to support two high level digital signature standard functions—signature generation and signature verification. An application can initiate performance of the function via a function call supported by the firmware API. As described above, firmware 115 decomposes each of these high level functions into sequences of operations required to perform the function.

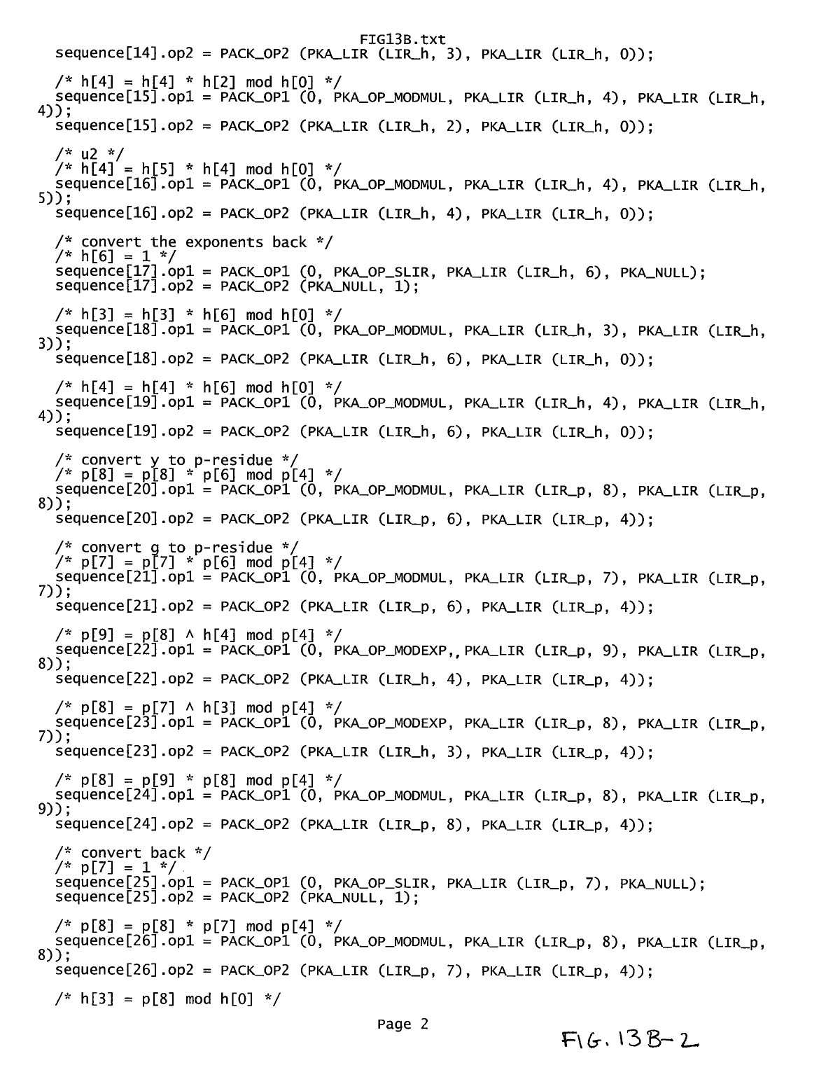

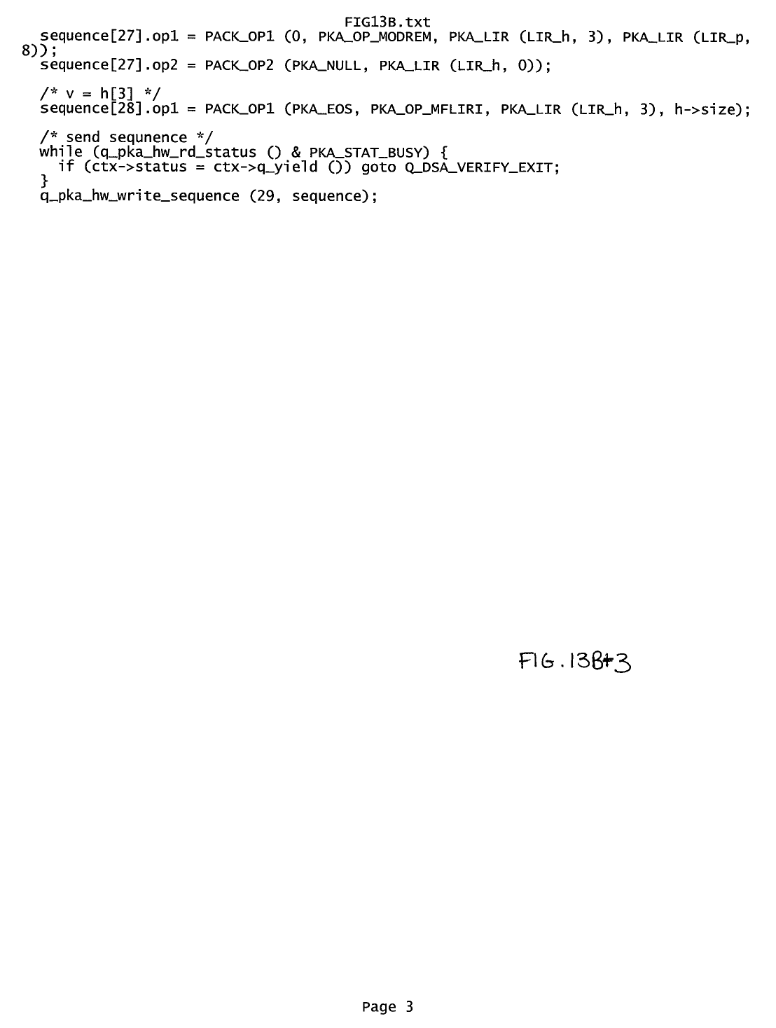

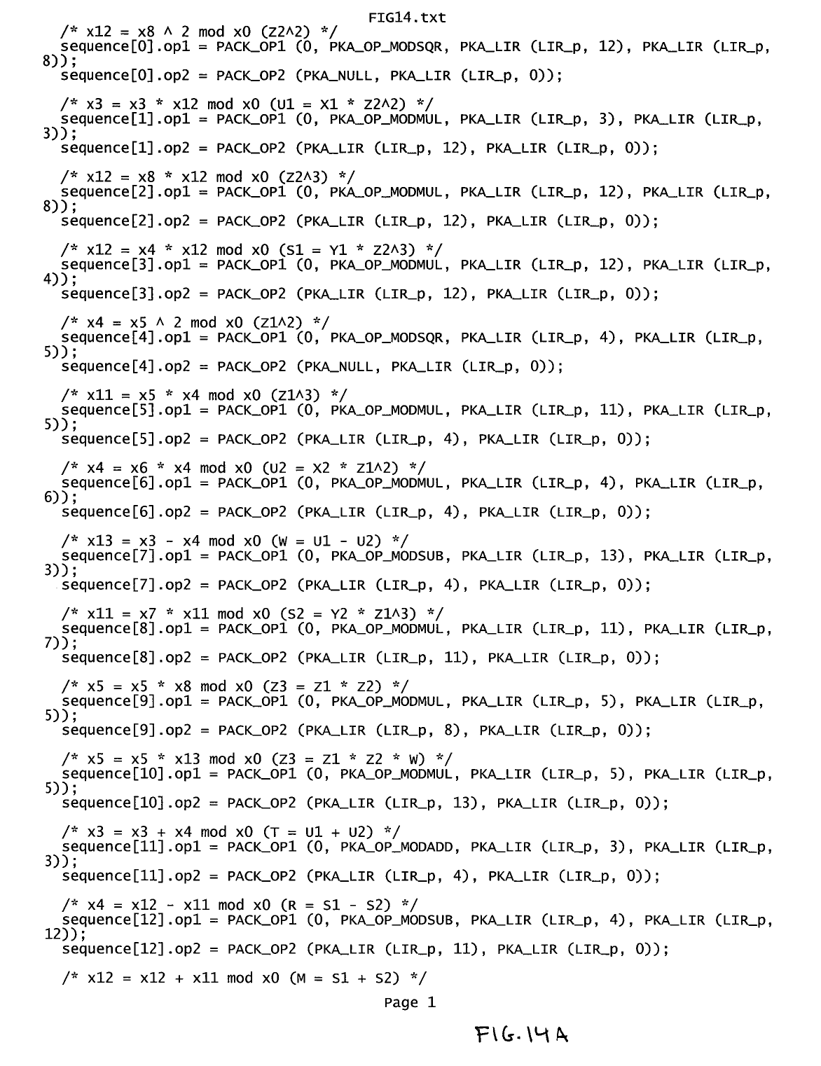

FIGS. 13A1-3 depict exemplary micro code sequence 1300A generated by firmware 115 for performing DSA signature generation, according to an embodiment of the present invention. The instructions 0 load the parameters required to perform the DSA signature generation, effectuate the DSA signature generation function, and unload the results, r and s.

FIG. 13B1-3 depict exemplary micro code sequence 1300B generated by firmware 115 for performing DSA signature verification, according to an embodiment of the present invention. The instructions load the parameters required to perform the DSA signature verification, effectuate the DSA signature verification function, and unload the result.

### 2.4 Elliptical Curve Cryptography

Elliptical curve cryptography (ECC) is based on the structure of elliptical curves over a finite field. The following section describes core aspects of elliptical curve cryptography.

### 2.4.1 Finite Fields

Mathematically, an abelian group satisfies a set G of elements together with a binary operation ⋄ such that the following are satisfied:
Closure—for elements x, y in G, x⋄y G
Associativity—for all elements x, y, and z in G, (x⋄y)⋄z=x⋄(y⋄z)
Identity—there exists an element e in G such that e⋄x=x⋄e=x for all x in G
Inverse—for all x in G there exists y in G such that y⋄x=x⋄y=e
Abelian—for all elements x, y in G y⋄x=x⋄y
   A finite field defines a finite set F together with two binary operations + and × that satisfies:
F is an abelian group with respect to “+”
F is an abelian group with respect to “×”
Distributive, for all X, Y and Z in F

X×(Y+Z)=X×Y+X×Z

(X+Y)×Z=X×Z+Y×Z

### 2.4.2 Elliptic Curve

Elliptical curve cryptography operates based on the finite field of all the points (x,y) on an elliptic curve. For ECC, two types of finite fields are typically used, the prime field Fp and the binary field F2̂n.

Let p be a prime number and p>3, a finite field Fp, called a prime field, can be considered to consist of the set of integers {0, 1, 2, . . . , p−1}.The elliptic curve of the prime field satisfies the following equation:

Y²=X³+aX+b

where a, bεFp satisfy

4a³+27b²≠0(mod p)

For the binary field F2̂n, the equation of the elliptical curve can be expressed as:

Y²+XY=X³+aX+b

where a, bεF2̂n and b≠0.
Point addition and point multiplication can be specified on the elliptic curve where:

Q(x,y)=P₁(x,y)+P₂(x,y)

Represents point addition operation and

Q(x,y)=k*P₁(x,y)

Represents point multiplication. k is an integer.

The point addition and point multiplication are operations defined in the finite field. In particular, the point multiplication is decomposed into a sequence of point doubling and point addition operations based on the representation of k. Point doubling is defined as:

Q(x,y)=2*P₁(x,y)=P₁(x,y)+P₁(x,y)

The basic method for computing Q=k*P is based on the binary representation of k. If

$$k = {\sum }_{j = 0}^{l - 1} {k}_{j} {2}^{j}$$

where each kⱼε{0,1}, then k*P can be computed as

$$kP = {\sum }_{j = 0}^{l - 1} {k}_{j} {2}^{j} P = 2 ( … 2 ( 2 {k}_{l - 1} P + {k}_{l - 2} P ) + … ) + {k}_{0} P$$

This equation uses iterative point doubling and point addition to compute k*P. Optimized methods such as NAF can be used to reduce the number of point additions, therefore reduces the computing time. However, the optimization of the two basic point operations, point doubling and point addition ultimately determine the performance of elliptic curve operation.

### 2.4.3 Elliptic Curve Point Addition and Point Doubling Prime Field

The point addition operation can be defined on the elliptic curve E(Fp) as:

Q(x,y)=P₁(x₁,y₁)+P₂(x₂,y₂)

### Where

$$\begin{matrix}{x}_{3} = {λ}^{2} - {x}_{1} - {x}_{2} , {y}_{3} \\ = λ ( {x}_{1} - {x}_{3} ) - {y}_{1}\end{matrix}$$

$$and$$

$$λ = \frac{{y}_{2} - {y}_{1}}{{x}_{2} - {x}_{1}}$$

When P₁=P₂, the operation is redefined as point doubling:

$$\begin{matrix}{x}_{3} = {λ}^{2} - 2 {x}_{1} , {y}_{3} \\ = λ ( {x}_{1} - {x}_{3} ) - {y}_{1}\end{matrix}$$

$$and$$

$$λ = \frac{3 {x}_{1}^{2} - a}{2 {y}_{1}}$$

Careful analysis shows that the point addition operation requires one inversion, two multiplications, one squaring and six additions. The point doubling operation requires one inversion, two multiplications, two squaring and eight additions. All operations are finite field operations that require modular math. The inversion in a prime field can be realized as a modular exponentiation according to Fermat's Little Theorem.

A straight forward implementation of the above equations is quite costly due to the modular exponentiation required to compute the inverse. Practical implementation would convert the affine coordinates of the points to a projective coordinate system. For prime field, affine coordinates (x,y) can be converted to projective coordinates (X,Y,Z) where:

$$x = \frac{X}{{Z}^{2}} , y = \frac{Y}{{Z}^{3}}$$

After the conversion, the inversion can be avoided from the point addition and point doubling operations. The point addition operation is converted into the following sequence:

U₁=X₁Z₂²

S₁=Y₁Z₂³

U₂=X₂Z₁²

S₂=Y₂Z₁²

W=U₁−U₂

R=S₁−S₂

T=U₁+U₂

M=S₁+S₂

Z₃=Z₁Z₂W

X₃=R²−TW²

V=TW²−2X₃

2Y₃=VR−MW³

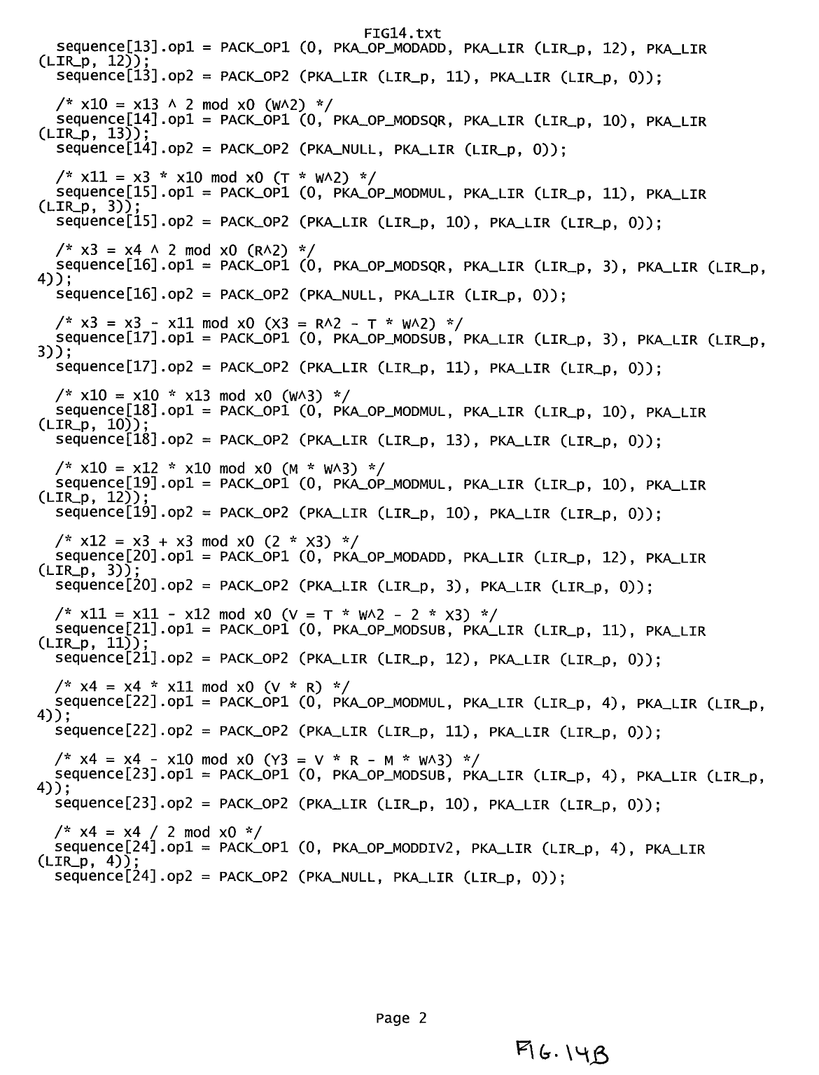

In an embodiment, the PKA firmware is designed to support prime field elliptical curve cryptography point addition. An application can initiate performance of prime field point addition via a function call supported by the firmware API. As described above, firmware 115 decomposes the point addition function into sequences of required operations. FIGS. 14A,B depict an exemplary micro code sequence 1400 generated by firmware 115 for performing prime field elliptical cryptography point addition, according to an embodiment of the present invention.

The point doubling operation is converted into the following sequence:

M=3X₁²+aZ₁⁴

Z₃=2Y₁Z₁

S=4X₁Y₁²

X₃=M²−2S

T=8Y₁⁴

Y₃=M(S−X₃)−T

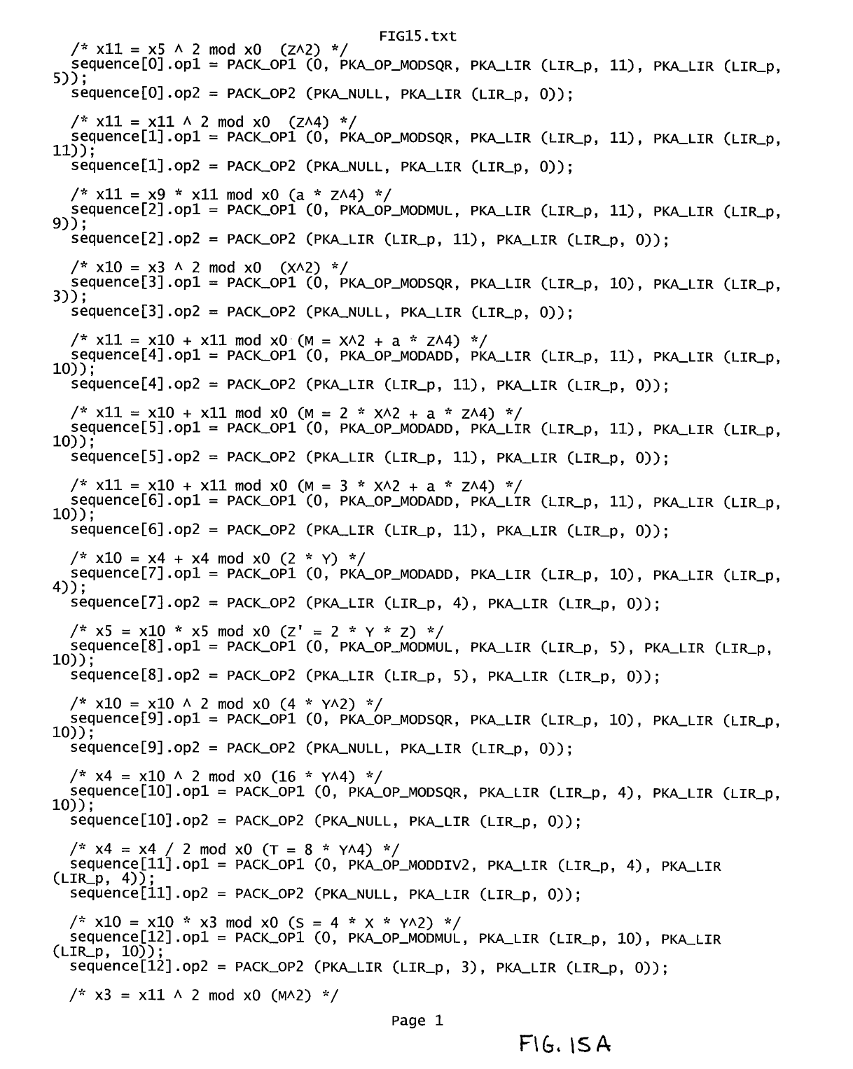

In an embodiment, the PKA firmware is designed to support prime field elliptical curve cryptography point doubling. An application can initiate performance of prime field point doubling via a function call supported by the firmware API. As described above, firmware 115 decomposes the point doubling function into sequences of required operations. FIGS. 15A,B depict an exemplary micro code sequence 1500 generated by firmware 115 for performing prime field elliptical cryptography point doubling, according to an embodiment of the present invention.

### 2.4.4 Elliptic Curve Diffie-Hellman (ECDH)

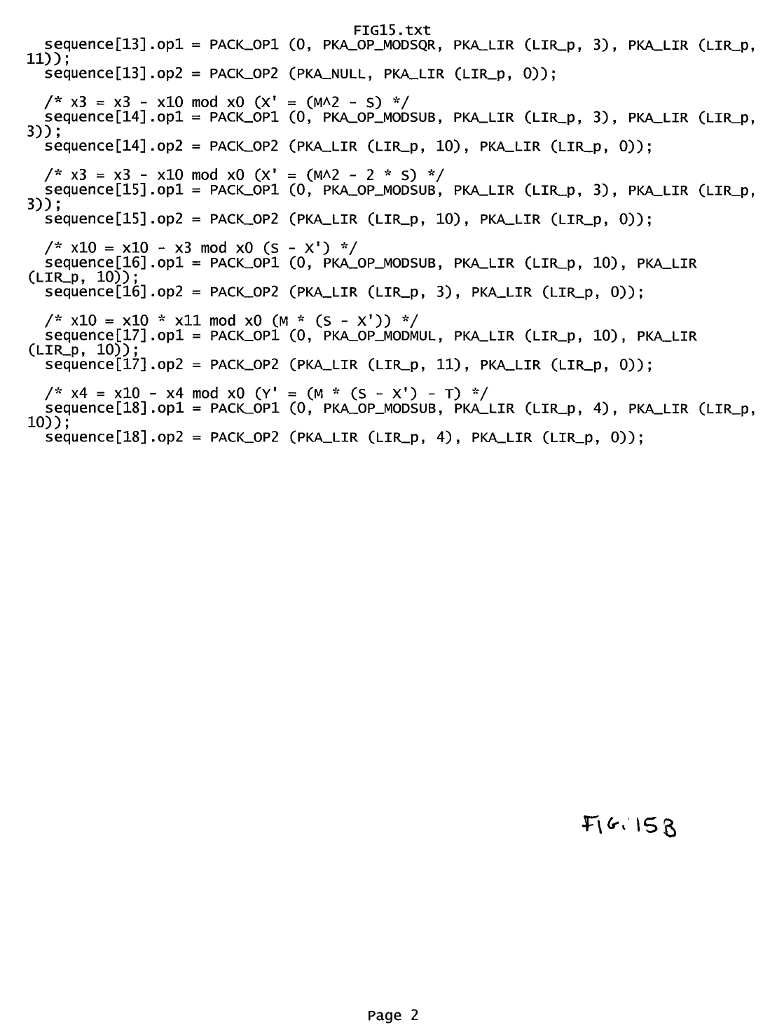

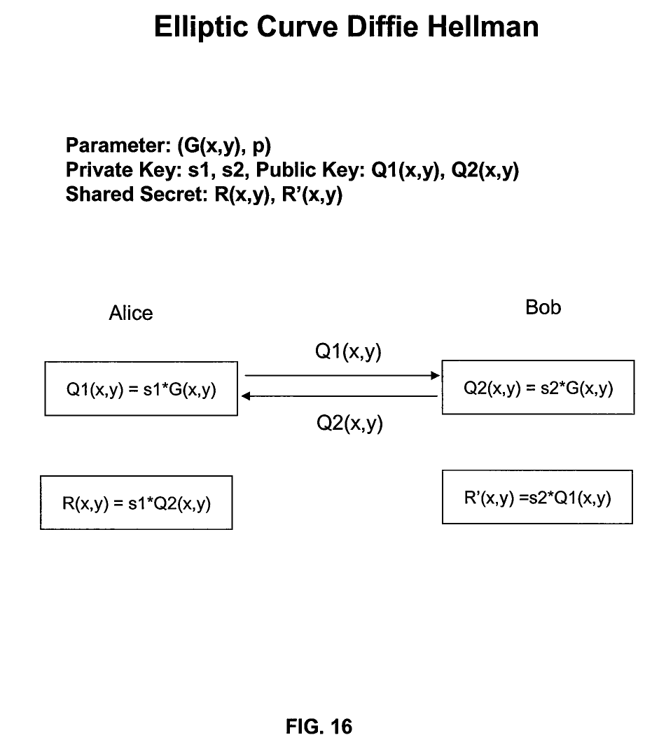

FIG. 16 depicts an exemplary Elliptic Curve Diffie-Hellman key exchange. The operation of ECDH requires both parties (Alice and Bob) in communication to compute an elliptic curve point multiplication using a randomly generated secret and a pre-negotiated base point G. So:

P=s1*G

Q=s2*G

Where s1 and s2 are secrets kept by party 1 (Alice) and party 2 (Bob) respectively. P and Q are exchanged by the parties. Afterwards, party 1 (Alice) computes S=s1*Q=s1s2*G and Bob computes S=s2*P=s1s2*G. The x coordinate of point S is the ECDH shared secret.

### 2.4.5 Elliptic Curve Digital Signature Algorithm (ECDSA)

The ECDSA operation includes both the signing operation and signature verification operation. The ECDSA signature is generated in the following manner. First, the hash of the message is computed as e=Hash(M). In an embodiment, a SHA-1 hash is used. Next the base point G of an elliptic (ECP or EC2N) with order n (modulus) is selected. The ECDSA private key, d, is selected and the elliptic curve point Q=d*G is computed. Q is then the ECDSA public key of the party. A random value k is then selected per signature and is used to compute the elliptic curve point R=k*G. The two components of the signature, r and s are then computed as r=x mod n and s=k−1(e+dr) mod n.

The ECDSA verify operation includes the following steps. First, the hash of the message is computed as e=Hash(M). In an embodiment, a SHA-1 hash is used. The inverse of e is then computed as e′=e−1 mod n; c is computed as c=(s′)−1 mod n and u1=e′c mod n and u2=r′c mod n. The elliptic curve point (x1, y1)=u1*G+u2*Q is then computed. The value v is then computed as x1 mod n. The value v is then compare to r′. If the result is equal, the signature is verified.

### 2.5 Modular Operations

Modular exponentiation is the predominant computation in public key algorithms. Modular exponentiation is typically done through iterations of modular multiplications based on the value of the exponent. The optimization of modular exponentiation results from reducing the number of modular multiplications and from reducing the computation time for modular multiplication.

A modular multiplication operation may be performed by interleaving multiplication and modular reduction. Alternatively, modular multiplication can be performed by multiplying the numbers first then performing the reduction

### 2.5.1 Classical Modular Reduction

Classical modular reduction is the traditional pencil-and-paper way of doing long division to find out the quotient and the remainder. In each step of iteration, one digit of the quotient (q) is estimated from the most significant bits of the dividend (z) and the divisor (n). The error of the estimate can be corrected afterwards by examining the sign bit of the subtraction z-qn.

### 2.5.2 Barrett's Method of Modular Reduction

Barrett's method of modular reduction replaces the sequential trial-divisions with two multiplications with the one time overhead of computing the reciprocal of the modulus (divisor). Barrett's method states:
A, B and M are given as n-bit integers to computer X=A*B mod M
Observing X=W−M*(W div M)=W−M*(W*R) where R is the reciprocal of M, a real number
Approximating R with an (n+1)-digit of base-b integer r=b²ⁿ mod M, X can be computed with the following steps:
   Take the most significant n+1 digits of W and multiply it by r, Q₂=[W div bⁿ⁻¹]*r
   Multiply the most significant n+1 digits of Q₂ by M, Q₃=[Q₂ div bⁿ]*M
   Subtract the n+1 least significant digits of Q₃ from the corresponding part of W, Y=W mod bⁿ⁻¹−Q₃ mod bⁿ⁻¹
   While Y>=M, Y=Y−M
      Barrett proves that Y is in the range of (0<=Y<3M) and only 1% of the case X will exceed 2M, which requires two subtractions.

### 2.5.3 Montgomery's Method

Montgomery's method replaces the division-by-n operation with a division-by-a-power-of-2. Let r=2^{k}, Montgomery's method requires that the modulus n is relatively prime to r. This is satisfied if n is odd.

Montgomery's method defines an n-residue number α for any integer a<n such that α=a*r mod n. The residue numbers for all integers less than n form a complete residue system.

Given two numbers a and b and their residues, α and β, the Montgomery product is defined as [symbol] =α*β*r⁻¹ mod n. It is observed that α*b*r⁻¹ mod n=(a*r)*b*r⁻¹ mod n=a*b mod n. Therefore, the task of computing modular multiplication becomes computing the Montgomery product of (α, b). This can be computed by the following steps:

α=a*r mod n

t=α*b

m=t*ñ mod r

R=(t+m*n)/r

if R>n then R=R−n

The integer ñ satisfies r*r⁻¹−n*ñ=1. The advantage of Montgomery's method is that the ‘mod n’ operation is completely moved out from the main computation with the pre-computing of r⁻¹ and ñ. This has significant benefit when it comes to performing modular exponentiation because of the overhead of pre-computing is negligible when the main computation is iterated many times.

In an embodiment of the present invention, hardware module 130 supports modular multiplication using Montgomery's method. As described above, in the Montgomery method, the input variables are converted to a residue numbering system. This conversion is handled by firmware 115 using optimized routines. Alternatively, the conversion may be partially offloaded to PKA hardware using a different sequence. The subsequent operations are based on the Montgomery context for the residue system represented by two variables, r⁻¹ and ñ. Both are about the same size as the modulus n. Optimization can be done on the Montgomery multiplication algorithm so that only the least significant word of ñ is stored. The hardware implementation assumes that the Montgomery Context would be stored in a contiguous piece of internal memory.

The use of Montgomery's method impacts the mapping of the LIR memory. For example, the size of the register file is determined by the requirement to perform a 4096-bit modular exponentiation using Montgomery's method. If this requirement is reduced, then the size of the LIR memory is also reduced.

Using Montgomery's method, in addition to the storage required for the base and exponent, the storage Montgomery Context and two double-sized temporary storage locations are also required. The total comes out to be eight locations of the size of the modulus. Since elliptical curve cryptography typically uses small size modulus, the LIR memory is well-sized to support complicated sequences if 4096-bit or 2048-bit modular exponentiation has to be supported. However, if the maximum modulus size for modular exponentiation is significantly reduced, then the LIR memory size might be bound by operations like elliptical curve cryptography rather than modular exponentiation.

### 2.5.4 Fast Modular Exponentiation

A conventional approach to performing modular exponentiation M^{e} (mod n) is to perform a binary scan of the exponent and raise the power of the base repeatedly, accumulatively multiplying the number when the corresponding exponent bit is a ‘1’. This approach typically requires about 1.5w times of modular multiplications for an exponent of w-bit wide because the base has to be raised w times and about half of the times a ‘1’ will be encountered. A variety of techniques have been used aiming to reduce the number of multiplications. The most common ones are the m-array method and the recording method.

In general, these methods rely on pre-computing certain powers of the base. Therefore, these methods work well in public key algorithms such as Diffie-Hellman algorithm where the base is known prior to the operation. In algorithms such as RSA, the base is converted from the cipher message. There is less advantage to pre-compute. Another disadvantage is that these methods require extra storage to keep the pre-computed values.

### 2.6 Prime Number Preselection

In an embodiment, hardware module 130 supports a prime number preselection operation. The prime number preselection operation can be accessed via a dedicated opcode (e.g., PPSEL).

Prior approaches to generate a prime number generates a large odd random number X followed by the primality test of X, X+2, X+4, . . . until a prime number is found. To speed up the process and offload the CPU bandwidth, a prime number preselection algorithm sifts the large odd random numbers which are the multiples of the prime numbers smaller than 32. By this pre-selection process, the performance of the prime number generation can be improved by a factor of 2.8 with less circuit addition.

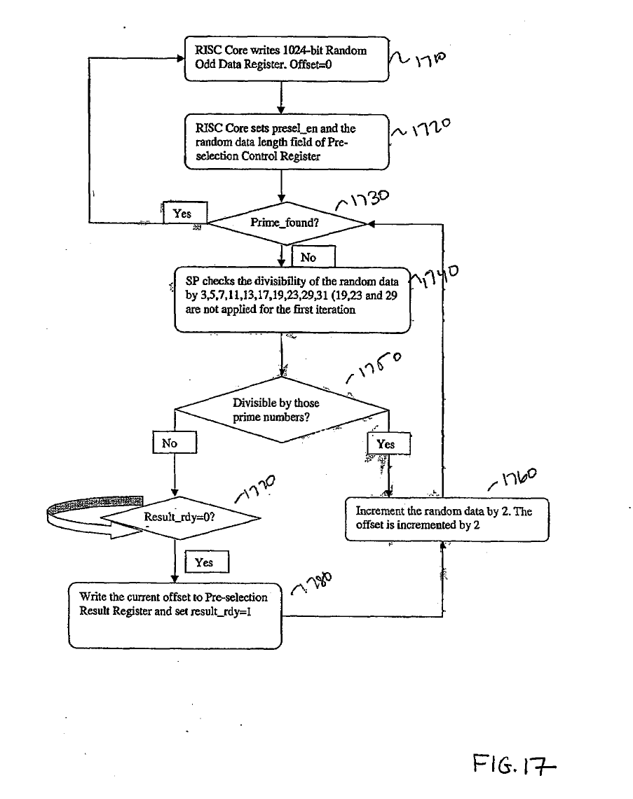

FIG. 17 depicts a flowchart of an exemplary method for performing prime number preselection using the sifting approach, according to embodiments of the present invention.

In step 1710, the hardware core writes the pre-selection odd data register with offset=0.

In step 1720, the core sets the preselect enable signal (presel_en) and the random data length field of the pre-selection control register. This action starts the logic based prime number selection.

To maintain flexibility, the core can program a field (e.g., random_data_len field) to let the hardware pre-select various sized prime number.

In step 1730, a determination is made whether a prime number has been found. If a prime number has not been found, flowchart proceeds to step 1730. If a prime number has been found, flowchart returns to step 1710.

In step 1740, the selection of prime number logic block starts the pre-selection process by calculating the remainders of the division of the random data by the small prime numbers like 3, 5, 7, etc.

In step 1750, a determination is made whether the random data is divisible by those small prime numbers. If the random data is divisible, flowchart proceeds to step 1760. If the random data is not divisible, flowchart proceeds to step 1770.

If the random data is divisible, in step 1760, the last random data is incremented by 2 and the flowchart returns to step 1730.

If the random data is not divisible by those small prime numbers, the selection of prime numbers logic asserts result_rdy signal and tells the cord that the offset of the random data from the initial random data.

In step 1770, a determination is made whether the result_rdy signal is 0, if the result_rdy signal is 0, flowchart proceeds to step 1780.

In step 1780, the current offset is written to the pre-selection result register and the result_rdy signal is set to 1. Flowchart the proceeds to step 1760.

Steps 1730 through 1760 iterate until all small prime numbers are tested for the divisibility. Before the selection of prime number logic writes the current offset to pre-selection result register, the logic checks the result_rdy signal to make sure the last result has been read.

### 3. Exemplary Computer System

The embodiments of the present invention, or portions thereof, can be implemented in hardware, firmware, software, and/or combinations thereof.

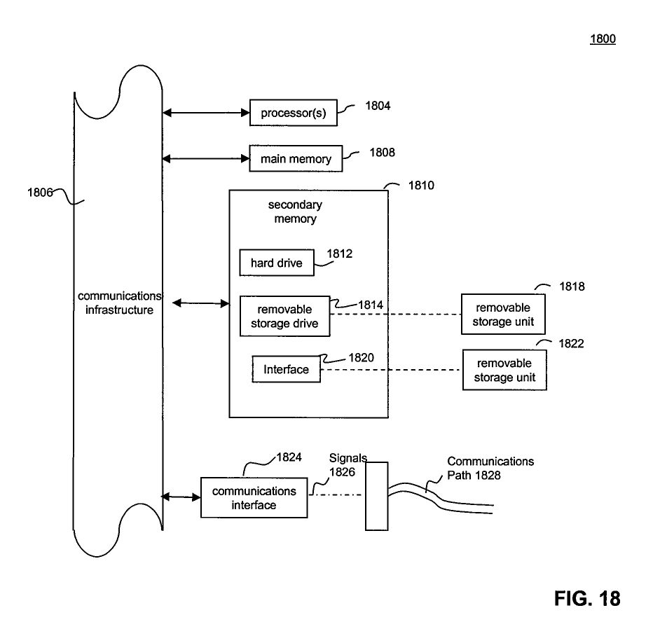

The following description of a general purpose computer system is provided for completeness. Embodiments of the present invention can be implemented in hardware, or as a combination of software and hardware. Consequently, embodiments of the present invention, may be implemented in the environment of a computer system or other processing system. An example of such a computer system 1800 is shown in FIG. 18. The computer system 1800 includes one or more processors, such as processor 1804. Processor 1804 can be a special purpose or a general purpose digital signal processor. The processor 1804 is connected to a communication infrastructure 1806 (for example, a bus or network). Various software implementations are described in terms of this exemplary computer system. After reading this description, it will become apparent to a person skilled in the relevant art how to implement the invention using other computer systems and/or computer architectures.

Computer system 1800 also includes a main memory 1808, preferably random access memory (RAM), and may also include a secondary memory 1810.

The secondary memory 1810 may include, for example, a hard disk drive 1812, and/or a removable storage drive 1814, representing a floppy disk drive, a magnetic tape drive, an optical disk drive, etc. The removable storage drive 1814 reads from and/or writes to a removable storage unit 1818 in a well known manner. Removable storage unit 1818, represents a floppy disk, magnetic tape, optical disk, etc. As will be appreciated, the removable storage unit 1818 includes a computer usable storage medium having stored therein computer software and/or data.

In alternative implementations, secondary memory 1810 may include other similar means for allowing computer programs or other instructions to be loaded into computer system 1800. Such means may include, for example, a removable storage unit 1822 and an interface 1820. Examples of such means may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communications interface 1824. Communications interface 1824 allows software and data to be transferred between computer system 1800 and external devices. Examples of communications interface 1824 may include a modem, a network interface (such as an Ethernet card), a communications port, a PCMCIA slot and card, etc. Software and data transferred via communications interface 1824 are in the form of signals 1828 which may be electronic, electromagnetic, optical or other signals capable of being received by communications interface 1824. These signals 1828 are provided to communications interface 1824 via a communications path 1826. Communications path 526 carries signals 528 and may be implemented using wire or cable, fiber optics, a phone line, a cellular phone link, an RF link and other communications channels.

The terms “computer program medium” and “computer usable medium” are used herein to generally refer to media such as removable storage drive 1814, a hard disk installed in hard disk drive 1812, and signals 1828. These computer program products are means for providing software to computer system 1800.

Computer programs (also called computer control logic) are stored in main memory 1808 and/or secondary memory 1810. Computer programs may also be received via communications interface 1824. Such computer programs, when executed, enable the computer system 1800 to implement the present invention as discussed herein. In particular, the computer programs, when executed, enable the processor 1804 to implement the processes of the present invention. Where the invention is implemented using software, the software may be stored in a computer program product and loaded into computer system 1800 using raid array 1816, removable storage drive 1814, hard drive 1812 or communications interface 1824.

### 4. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for performing a cryptographic function in a cryptosystem, wherein the cryptosystem includes a microprocessor having firmware coupled to a hardware module, comprising:
receiving a request for a cryptographic function from an application, wherein the request includes an input parameter for the cryptographic function;
accessing a sequence of operations required to perform the requested cryptographic function, wherein an operation in the sequence of operations is an operation supported by the hardware module;
preparing a micro code sequence for the hardware operation, wherein the micro code sequence includes a set of micro code instructions;
sending the micro code sequence to the hardware module;
reading the result of the micro code sequence from the hardware module; and
sending the result of the cryptographic function to the requesting application.

2. The method of claim 1, further comprising:
reading an intermediate result prior to reading the result of the micro code sequence from the hardware module.

3. The method of claim 1, wherein the micro code sequence sent to the hardware module includes source data, the method further comprising:
reading the source data from the hardware module prior to reading the result of the micro code sequence from the hardware module.

4. The method of claim 1, wherein the sequence of operations includes a firmware operation and the method further comprises:
performing the firmware operation prior to sending the result of the cryptographic function to the requesting application.

5. The method of claim 1, further comprising:
prior to sending the result of the cryptographic function to the requesting application,
preparing a second micro code sequence for a second hardware operation, wherein the second micro code sequence includes a set of micro code instructions;
sending the second micro code sequence to the hardware module;
reading the result of the second micro code sequence from the hardware module

6. The method of claim 1, wherein preparing the micro code sequence includes:
preparing a set of load instructions, a set of data processing instructions, and a set of unload instructions.

7. The method of claim 1, further comprising:
performing a background function during a time period when the hardware module is processing the micro code sequence.

8. The method of claim 1, further comprising:
generating a sequence of operations required to perform a cryptographic function, wherein the sequence of operations uses a set of hardware operations supported by the hardware module;
storing the sequence of operations in a firmware library; and
providing an application programming interface call for invoking the cryptographic function.

9. The method of claim 8, wherein the sequence of operations is variable length.

10. The method of claim 8, wherein a size of the sequence of operations is limited by a size of an opcode FIFO in the hardware module.

11. A method for performing an operation in a cryptographic hardware accelerator module, comprising:
receiving a micro code sequence, wherein the micro code sequence includes a set of load instructions, a set of data processing instructions, and a set of unload instructions;
loading data into a memory in the hardware module, wherein the memory is a large integer memory;
processing a data processing instruction in the set of data processing instructions, wherein processing the data processing instruction includes:
decomposing the instruction into a set of lower level operations, and
passing each operation to a data path for processing;
unloading a result upon completion of each instruction in the micro code sequence; and
providing the result to a processor.

12. The method of claim 11, further comprising:
receiving a subsequent micro code sequence, wherein the second micro code sequence includes a set of load instructions, a set of data processing instructions, and a set of unload instructions;
processing a data processing instruction in the set of data processing instructions of the subsequent micro code sequence, wherein the processing utilizes data loaded by the prior micro code sequence.

13. The method of claim 11, further comprising:
parsing a load instruction in the set of load instructions, wherein the load instruction includes a register operand and data to be loaded.

14. The method of claim 13, further comprising:
updating size information in a content addressable memory for an identified register in the register operand.

15. The method of claim 13, further comprising:
translating a register index in the register operand to a base address for the memory.

16. The method of claim 15, wherein a data processing instruction the set of data processing instructions includes a register operand defining a register type for the register operand.

17. The method of claim 16, wherein the register type indicates a size for an associated register.

18. The method of claim 11, further comprising:
parsing the data processing instruction, wherein the data processing instruction includes a set of source register operands and a destination register operand.

19. The method of claim 18, wherein a source register in the set of source register operands is used as a destination register defined in the destination register operand.

20. The method of claim 18, further comprising:
retrieving size information for each source register identified in the set of source register operands.

21. The method of claim 20, further comprising:
computing size information for the destination register identified in the destination register operand.

22. The method of claim 21, further comprising:
transferring the size information for the source registers and destination registers to a micro sequencer.

23. A system of accelerating cryptographic operations, including:
a hardware module, wherein the hardware module supports a set of hardware operations;
a microprocessor coupled to the hardware module, wherein the microprocessor includes firmware configured to receive a request for a cryptographic function, to access a sequence of operations for performing the requested function, and to generate a micro code sequence to perform a hardware operation, wherein the micro code sequence includes a set of instructions; and
a firmware library, wherein the firmware library includes a set of hardware primitives configured to generate micro code sequences and a set of firmware primitives.

24. The system of claim 15, wherein the hardware module comprises:
a opcode parser for processing the set of instructions in the micro code sequence, wherein an instruction includes an opcode;
a micro sequencer coupled to the opcode parser, wherein the micro sequencer is configured to receive an opcode, to decompose the opcode into a set of lower level operations, and to process the opcodes in a predefined order;
a data path coupled to the micro sequencer, wherein the data path is configured to process the lower level operations; and
a memory, wherein the memory is mapped to a set of large integer registers indexed in one or more instructions in the micro code sequence.

25. The system of claim 24, wherein the memory supports a set of predefined large integer register types, each large integer register type having a different size and wherein each large integer register is associated with a predefined type in the set of predefined large integer register types.

26. The system of claim 25, wherein the opcode parser includes:
an operand size content addressable memory (CAM), wherein the operand size CAM is configured to store the size of data stored in a large integer register in the memory.

27. The system of claim 25, wherein an opcode in an instruction is a prime number selection opcode.

28. The system of claim 26, wherein the hardware module is configured to check the data size stored in the CAM whereby buffer overflow or underflow conditions are avoided.
